(19) United States
(12) Patent Application Publication
(10) Pub. No.: US 2018/0211353 A1
(43) Pub. Date: Jul. 26, 2018

(54) SYSTEMS AND METHODS FOR MANAGING SUBJECTIVE PROBABILITY BETTING INCLUDING USER-PROVIDED HANDICAPS AND PAYOUT RATES

(71) Applicant: Sak Mahasuverachai, Bangkok (TH)

(72) Inventor: Sak Mahasuverachai, Bangkok (TH)

(21) Appl. No.: 15/742,873

(22) PCT Filed: Jul. 7, 2016
(86) PCT No.: PCT/US2016/041307

§ 371 Date: Jan. 8, 2018

Related U.S. Application Data
(60) Provisional application No. 62/190,821, filed on Jul. 10, 2015.

(51) Int. Cl. G06Q 50/34; G07F 17/32

(52) U.S. Cl. CPC G06Q 50/34; G07F 17/3288

(57) ABSTRACT

Systems and methods are provided for managing subjective probability bets, the method comprising: receiving a set of bets; calculating one or more possible outcomes of a competition; for each possible outcome, determining whether each of the bets would be a winning bet or a losing bet; performing an iterative bet analysis procedure comprising: calculating a payable amount, calculating a payout amount, and determining whether the sum of the payable amount and a system threshold (indicating a maximum amount allowed to be paid out beyond the payable amount for the possible outcome) is greater than or equal to the payout amount; if it is determined that said sum is greater than or equal to the payout amount, assigning the outcome a pass value, and if it is determined that said sum is not greater than or equal to the payout amount, assigning the outcome a fail value.

### RELATED APPLICATIONS

The present application claims priority to and benefit of, and incorporates herein by reference in its entirety, U.S. Provisional Application No. 62/190,821, filed Jul. 10, 2015.

### FIELD

The present invention generally relates to bet management, and more particularly to systems and methods for managing bets of subjective probability games in which users provide desired bet handicaps and payout rates.

### BACKGROUND

In the gambling industry, several types of betting games exist including pure probability games, skill and luck games, subjective probability games, and pure skill games. Pure probability games are games such as slot machine or roulette, in which players (e.g., bettors) play solely on chance. Skill and luck games are games such as poker or black jack, in which it is possible for players to use skill to increase their chances of winning. However, skill and luck games are still played partly on probability. Subjective probability games are games such as sport betting or horse betting, in which players (e.g., bettors) may have their own perspective on the probability of the outcome of the game. There is no randomness in this type of game, but there is uncertainty that prevents anyone from predicting the outcome. Pure skill games are games such as chess or participating in a sport, in which players use their own skills to settle the outcome. This type of gambling game is not very common to play on a large scale because of the complication of settling on the opponent and the game environments.

Subjective probability games include events in which multiple parties consent on betting, including sports (e.g., soccer, horse racing) and elections. Typically, in subjective probability games, the outcomes of the games are not 50-50 (e.g., even). Instead, there is often a favorite team and an underdog. The favorite team generally has an advantage such as the skill of the team (or side (e.g., candidate)), the location of play, or the like. When betting on subjective probability games, it is possible to reduce and/or eliminate advantages or disadvantages between the favorite and underdog teams using mutually agreed upon concepts including, for example, handicaps or payout rates.

Handicaps generally refer to the concept of providing an underdog team with an advantage. Payout rates generally refer to the concept of reducing the payout for the favorite team with advantages, and increasing the payout for the team with disadvantages. Betting services exist that assist in the process of calculating handicaps and payout rates, and/or matching bettors that agree on the proper handicap and/or payout rates.

Traditional bookmakers (e.g., bookies) generally serve as a player in the bet, providing handicaps and payout rates for other players. A traditional bookmaker or bookmaker system succeeds (e.g., makes money, wins) by lower payout rates for both the favorite and underdog teams in order to collect the difference as a service fee. Traditional bookmaker systems are generally understood by players and allow the players to submit bets almost on any game or event. However, players are the ones covering the service fee (which can often be high) earned by the traditional bookmaker systems, since the bookmakers have a better payout rate than players who bet with them. Moreover, players may not ask for their own payout rate when using traditional bookmaker systems, and instead are forced to bet from limited handicap and payout rate options provided by the bookmaker. On the other hand, bookmaker systems are tasked with calculating the most ideal handicaps and taking on a large amount of risk.

Peer-to-peer betting systems (e.g., betting exchanges), serve as impartial third party systems that provides a place for players to exchange bets. That is, the peer-to-peer system acts similar to a stock exchange, where the system makes money by charging a certain percentage commission from the winners. Peer-to-peer systems generally result in lower service fees for the players, and players have the ability to lay a bet. The peer-to-peer system is subject to minimal or no risk by serving as an impartial system that simply collects operation (e.g., service) fees from the players. Peer-to-peer systems generally incur less work by not having to calculate payout rates in order to balance their risk. On the other hand, because of the low volume of bettors using peer-to-peer systems, there is a high learning curve for players and a lower amount of profits for the peer-to-peer system.

### SUMMARY

The example embodiments presented herein are directed to systems and methods for managing subjective probability bets.

In some example embodiments, a method is provided for managing subjective probability bets, the method comprising: receiving, by the processor of a computing device, (e.g., from a bettor computing device, from an operator computing device) a first set of bets including one or more bets associated with a competition, each of the bets in the first set of bets including at least a winner (e.g., pick, desired side of bet), a payout rate, and a bet amount; calculating, by the processor, one or more possible outcomes of the competition; for each of the possible outcomes of the competition, determining whether each of the bets in the first set of bets would be a winning bet or a losing bet; removing, by the processor, duplicate outcomes from the possible outcomes to arrive at a set of remaining possible outcomes; for each of the remaining possible outcomes, performing, by the processor, a first iteration of a bet analysis procedure using the bets in the first set of bets, the bet analysis procedure comprising: calculating, by the processor, a payable amount, the payable amount indicating incoming money from losing bets; calculating, by the processor, a payout amount, the payout amount indicating outgoing money from winning bets; determining, by the processor, whether the sum of the payable amount and a system threshold is greater than or equal to the payout amount, the system threshold indicating a maximum amount allowed to be paid out beyond the payable amount for the possible outcome; in the event that it is determined that the sum of the payable amount and the system threshold is greater than or equal to the payout amount, assigning, by the processor, the outcome a pass value (e.g., no need to reiterate flag), indicating that the bets in the first set of bets are acceptable for the possible outcome; and in the event that it is determined that the sum of the payable amount and the system threshold is not greater than or equal to (e.g., less than) the payout amount: (i) assigning, by the processor, the outcome a fail value (e.g., need to reiterate flag), indicating that the bets in the first set of bets are not acceptable for the possible outcome (e.g., rejected bets); and (ii) moving, by the processor, at least a portion of one or more of the bets (e.g., rejected bets) in the first set of bets to a rejected list of bets.

In some example embodiments, the method comprises determining, by the processor, whether any of the possible outcomes include a fail value (e.g., need to reiterate flag); and in the event that it is determined, by the processor, that at least one of the possible outcomes includes a fail value (e.g., need to reiterate flag): sorting, by the processor, the winning bets for the possible outcome in accordance with a predetermined algorithm, wherein the first of the sorted winning bets is the first bet to be processed in the bet analysis procedure, wherein, in the bet analysis procedure, the sorted winning bets are processed sequentially, starting with the first of the sorted winning bets, to determine if the winning bet is accepted or rejected (e.g., moved to the rejected list of bets).

In some example embodiments, the method comprises determining, by the processor, whether any of the possible outcomes include a fail value (e.g., need to reiterate flag); and in the event that it is determined, by the processor, that at least one of the possible outcomes includes a fail value (e.g., need to reiterate flag): perform, for each of the remaining possible outcomes, by the processor, one or more additional iterations of the bet analysis procedure, wherein each of the one or more additional iterations of the bet analysis procedure is performed using the first set of bets and excluding the at least a portion of the one or more of the bets in the rejected list.

In some example embodiments, the bet analysis procedure succeeds (e.g., has a pass condition) if each of the remaining possible outcomes is assigned a pass value (no need to reiterate flag), and, if the bet analysis procedure succeeds, the bets in the rejected list are moved to a second set of bets.

In some example embodiments, bets in the first set of bets, originated from corresponding bettor computing devices, are received, via a network, from one or more operator computing devices (e.g., casino systems, bookie systems), and the bets in the second set of bets are transmitted (e.g., distributed), via the network, to the one or more operator computing devices for further processing (e.g., analysis and/or consideration as to whether the operator computing devices will accept or reject the bets independently).

In some example embodiments, a portion of a rejected bet is placed in the rejected list and the other portion of the rejected bet is accepted.

In some example embodiments, the predetermined algorithm is a heuristic algorithm for determining risk based on one or more of the payout ratio, bet amount and bet time of each of a bet.

In some example embodiments, the competition is a subjective probability type of competition including one or more of sports, events, and elections.

In some example embodiments, the bets include a bet option selected from the group comprising standard, over-under, handicap, and money line.

In some example embodiments, the method comprises calculating, by the processor, a standard payout rate based on payout rates and/or handicaps included in each of the bets, wherein the standard payout rate indicates the risk associated with each of the bets.

In some example embodiments, the bet analysis procedure is performed using one or more bets received during a predetermined amount of time (e.g., 5 minutes, 10 minutes, up to 1 hour before a match, up until halftime of a match) or continuously as each bet is received.

In some example embodiments, a system is provided for managing subjective probability bets, comprising: at least one memory; and a processor coupled to the at least one memory, the processor being operable to: receive (e.g., from a bettor computing device, from an operator computing device) a first set of bets including one or more bets associated with a competition, each of the bets in the first set of bets including at least a winner (e.g., pick, desired side of bet), a payout rate, and a bet amount; calculate one or more possible outcomes of the competition; for each of the possible outcomes of the competition, determine whether each of the bets in the first set of bets would be a winning bet or a losing bet; remove duplicate outcomes from the possible outcomes to arrive at a set of remaining possible outcomes; for each of the remaining possible outcomes, perform a first iteration of a bet analysis procedure using the bets in the first set of bets, the bet analysis procedure comprising: calculating a payable amount, the payable amount indicating incoming money from losing bets; calculating a payout amount, the payout amount indicating outgoing money from winning bets; determining whether the sum of the payable amount and a system threshold is greater than or equal to the payout amount, the system threshold indicating a maximum amount allowed to be paid out beyond the payable amount for the possible outcome; in the event that it is determined that the sum of the payable amount and the system threshold is greater than or equal to the payout amount, assigning the outcome a pass value (e.g., no need to reiterate flag), indicating that the bets in the first set of bets are acceptable for the possible outcome; and in the event that it is determined that the sum of the payable amount and the system threshold is not greater than or equal to (e.g., less than) the payout amount: (i) assigning the outcome a fail value (e.g., need to reiterate flag), indicating that the bets in the first set of bets are not acceptable for the possible outcome (e.g., rejected bets); and (ii) moving at least a portion of one or more of the bets (e.g., rejected bets) in the first set of bets to a rejected list of bets.

In some example embodiments, the processor is further operable to: determine whether any of the possible outcomes include a fail value (e.g., need to reiterate flag); and in the event that it is determined that at least one of the possible outcomes includes a fail value (e.g., need to reiterate flag): sort the winning bets for the possible outcome in accordance with a predetermined algorithm, wherein the first of the sorted winning bets is the first bet to be processed in the bet analysis procedure, wherein, in the bet analysis procedure, the sorted winning bets are processed sequentially, starting with the first of the sorted winning bets, to determine if the winning bet is accepted or rejected (e.g., moved to the rejected list of bets).

In some example embodiments, the processor is further operable to: determine whether any of the possible outcomes include a fail value (e.g., need to reiterate flag); and in the event that it is determined that at least one of the possible outcomes includes a fail value (e.g., need to reiterate flag): perform, for each of the remaining possible outcomes, one or more additional iterations of the bet analysis procedure, wherein each of the one or more additional iterations of the bet analysis procedure is performed using the first set of bets and excluding the at least a portion of the one or more of the bets in the rejected list.

In some example embodiments, the bet analysis procedure succeeds (e.g., has a pass condition) if each of the remaining possible outcomes is assigned a pass value (no need to reiterate flag), and wherein, if the bet analysis procedure succeeds, the bets in the rejected list are moved to a second set of bets.

In some example embodiments, bets in the first set of bets, originated from corresponding bettor computing devices, are received, via a network, from one or more operator computing devices (e.g., casino systems, bookie systems), and the bets in the second set of bets are transmitted (e.g., distributed), via the network, to the one or more operator computing devices for further processing (e.g., analysis and/or consideration as to whether the operator computing devices will accept or reject the bets independently).

In some example embodiments, a portion of a rejected bet is placed in the rejected list and the other portion of the rejected bet is accepted.

In some example embodiments, the predetermined algorithm is a heuristic algorithm for determining risk based on one or more of the payout ratio, bet amount and bet time of each bet.

In some example embodiments, the competition is a subjective probability type of competition including one or more of sports, events, and elections.

In some example embodiments, the bets include a bet option selected from the group comprising standard, over-under, handicap, and money line.

In some example embodiments, the processor is further operable to: calculate a standard payout rate based on payout rates and/or handicaps included in each of the bets, wherein the standard payout rate indicates the risk associated with each of the bets.

In some example embodiments, the bet analysis procedure is performed using one or more bets received during a predetermined amount of time (e.g., 5 minutes, 10 minutes, up to 1 hour before a match, up until halftime of a match) or continuously as each bet is received.

### BRIEF DESCRIPTION OF THE DRAWINGS

The foregoing and other objects, aspects, features, and advantages of the present disclosure will become more apparent and better understood by referring to the following description taken in conjunction with the accompanying drawings, in which:

FIG. 1 is a diagram of a system environment for managing bets, according to an exemplary embodiment.

FIG. 2 is a diagram of a flow chart illustrating a process for managing bets according to an exemplary embodiment.

FIGS. 3A and 3B are diagrams of the concept of standard payout rate.

FIG. 4 is a diagram of a bet management process is which all bets are matched, according to an exemplary embodiment.

FIGS. 5A and 5B are diagrams of a first and second iteration in a bet management process in which not all of the bets input by Players 01-05 are matched or covered, according to an exemplary embodiment.

FIG. 6 is a diagram of a bet management process in which no bets are matched, according to an exemplary embodiment.

FIG. 7 is a diagram of a bet management process in which different handicaps are used, according to an exemplary embodiment.

FIG. 8 is a diagram of a bet management process with different bet options, according to an exemplary embodiment.

FIG. 9 is a diagram of a bet management process in which system thresholds are used, according to an exemplary embodiment.

FIG. 10 is a diagram of a bet management process in which service fees are applied, according to an exemplary embodiment.

FIGS. 11A and 11B are diagrams of a first and second iteration of a bet management process not using a heuristic algorithm, according to an exemplary embodiment.

FIGS. 11C and 11D are diagrams of a first and second iteration of a bet management process using a heuristic algorithm, according to an exemplary embodiment.

FIG. 12 is a diagram of a bet management process including a subsequently placed bet, according to an exemplary embodiment.

FIG. 13 is a diagram of a graphical user interface for managing bets, according to an exemplary embodiment.

FIG. 14 is a diagram of a graphical user interface for modifying handicaps in a betting process, according to an exemplary embodiment.

FIG. 15 is a diagram of a graphical user interface for managing bets, according to an exemplary embodiment.

FIG. 16 is a diagram of a graphical user interface for managing bets, according to an exemplary embodiment.

FIG. 17 is a diagram of a wind graphical user interface for managing bets, according to an exemplary embodiment.

FIG. 18 is a diagram of a wind graphical user interface for managing bets, according to an exemplary embodiment.

FIG. 19 is a diagram of a wind graphical user interface for managing bets, according to an exemplary embodiment.

FIG. 20 shows an illustrative network environment for use in the methods and systems for managing bets, as described herein.

FIG. 21 shows an example of a computing device and a mobile computing device that can be used in the methods and systems described in this disclosure.

### DETAILED DESCRIPTION

### Definitions

“Bet Options” generally refer to rules used to settle how the players would win. One common bet option is a “standard” (STD) option, in which a player picks a team (or the like) to win the game, match, contest, event, etc. An event may be, for example, when a celebrity will get married, what will be the gender of the queen's child, etc. In standard bets, each team (or the like) is assigned a probability of winning and payouts for choosing a team are proportional to the odds of the team winning. Other bet options include “over-or-under” (OU), in which players bet whether the total score of the match (or the like) combined for the teams will exceed or fall under a certain predetermined number.

“Handicaps,” “point spreads,” and/or “lines” generally refer to an advantage given to an underdog team. Normally handicaps are used with the STD bet option to make appeal to players that the match is even. That is, the handicap, point spread or line generates a playing game in which both teams are evenly (or approximately evenly) matched. For example, if a soccer match between Brazil (e.g., the favorite team) and Thailand (e.g., the underdog team) appears as a STD option for player to bet, then a handicap of, for example, 3.5 goals would be calculated and given to Thailand to make the match even or more even. This would mean that whatever match outcome turns out to be, Thailand will have 3.5 goals added to their scores. A fraction of a score (e.g., goal, basket, run) is used to eliminate the chance that betting outcomes will be tied

“Payout Rate” and/or “odds” generally refers to a rate of pay given to the winner of the bet. Payout rate may be fractions, percentages or the like. For example, a 0.9 payout rate would mean that a winning player would receive 90% of his or her bet amount as a reward along with the initial bet. So if a player bets $100@0.9 payout rate and wins, the player would receive a total of $190 ($90 from the win, and $100 from the original bet). Other examples include: (1) a winning bet for $300@0.95, will receive $585; (2) a winning bet for $1000@0.10, will receive $1100; and (3) a winning bet for $1000@2.50, will receive $3500.

“Strong Team” and/or “favorite” refers to a team with an advantage or greater advantage in the match.

“Weak Team” and/or “underdog” refers to a team that has a lesser advantage or a disadvantage in a match.

“Money line” refers to a bet option with no handicap, although, in certain events a player may also be given an option to bet on the draw or tie outcome. For example, in money line options, the strong team will likely have a lower payout rate than the weak team. The difference between the payout rates on both teams will increase if the stronger team is much stronger (e.g., has more advantages) than the weak team

“System threshold” refers to an amount of money set by a betting system to control the system's risk. This number represents the system's predetermined maximum amount of money that a system is willing to tolerate to lose in a match, game or contest. That is, the system threshold indicates how much the system is willing to risk with any specific match. System threshold may be set to 0 by default, which would mean that the matching computation done by the system will never allow the system (e.g., system owner) to lose any money. By increasing the system threshold, the system allows the system owner to potentially lose money. As such, the system starts to become a player and starts taking bets with someone else in the system. However, this is still different from being another player placing their bets into the system because the system threshold is one single number computed under the optimization method.

“Payable amount” refers to the amount of money the system is expected to win from losing players in a case match outcome, which can then be used as payout to pay the winning players.

“Payout amount” refers to an amount of money needed to payout winners in specific computed cases or outcomes.

“Winner,” in the context of information submitted with a bet, refers to the chosen desired pick or side of a bet. For example, in a standard bet of a sports match, the winner refers to one of the two teams, who the bettor has picked to win the bet. In another example, in an over-under bet of a sports match, the winner is the over score or the under score of the match. That is, the winner refers to the winning side of the bet chosen by the bettor.

“Operator” and/or “operator computing device” refers to a bet taker or system operated by a bet taker, which may be a bookie, casino, or the like, operable to take bets from bettor systems and/or individuals. The operator and/or operator computing device may be communicatively coupled to the bettor systems (e.g., computing devices) and/or bet management system via one or more networks.

### System

Described herein is a bet management system. In some example embodiments, the bet management system is referred to as a “Betting Match Up” system. The bet management system, in some example embodiments, is a hybrid between traditional bookmakers or bookmaker systems and betting exchanges. The system may be a neutral bet taker, or can also serve as a participant (e.g., bettor) against other players. As described in further detail below, the bet management system is operable to compute input from different dimensions including different handicaps and bet options. In some example embodiments the bet management system is operable to calculate and provide optimal payout rates for other bookies (e.g., bookmakers) or bookmaker systems, by using the real demand and supply of the market (e.g., the bets, and requested handicaps and payout rates thereof), which represent the most accurate desired payout rates and handicaps of the public.

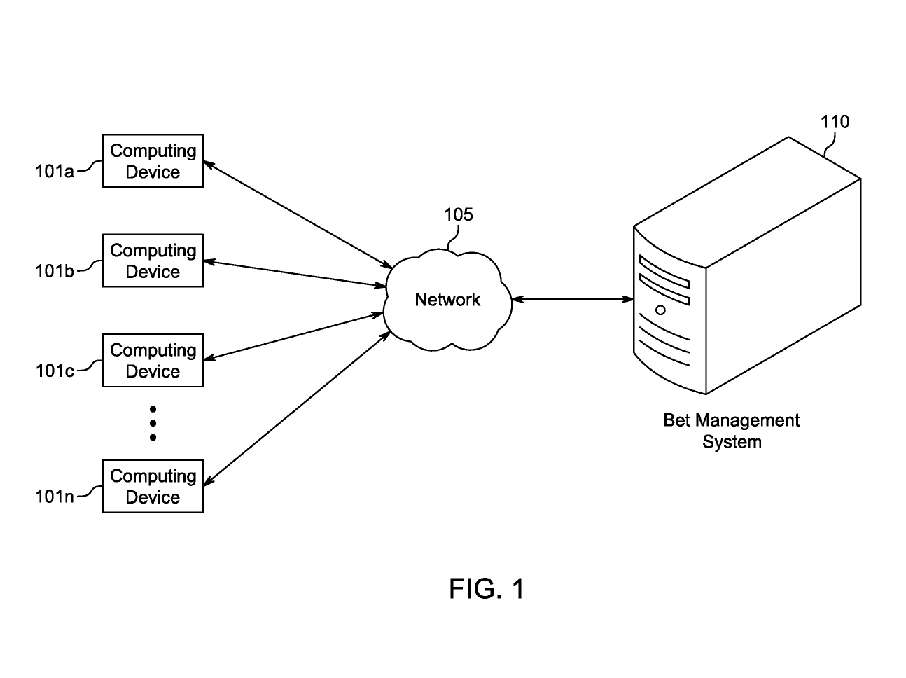

FIG. 1. illustrates a system environment for managing bets, according to an exemplary embodiment. FIG. 1 includes computing devices 101a, 101b, 101c, . . . , 101n (collectively “computing devices” and/or “101”). The computing devices are connected to a bet management system 110 via a network. The computing devices 101 may be laptops, desktop computers, smartphones, wearable devices, and the like, which are used, owned, and/or managed by players and/or bettors. That is, the players associated with the computing devices 101 interact with the bet management system 110 via the network 105.

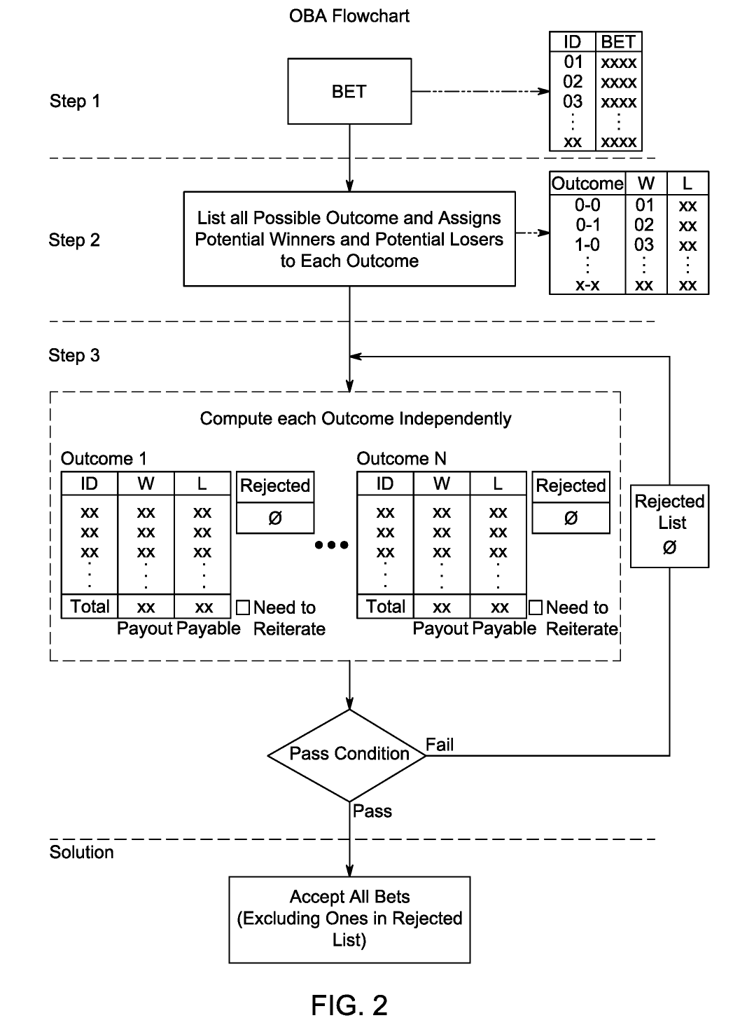

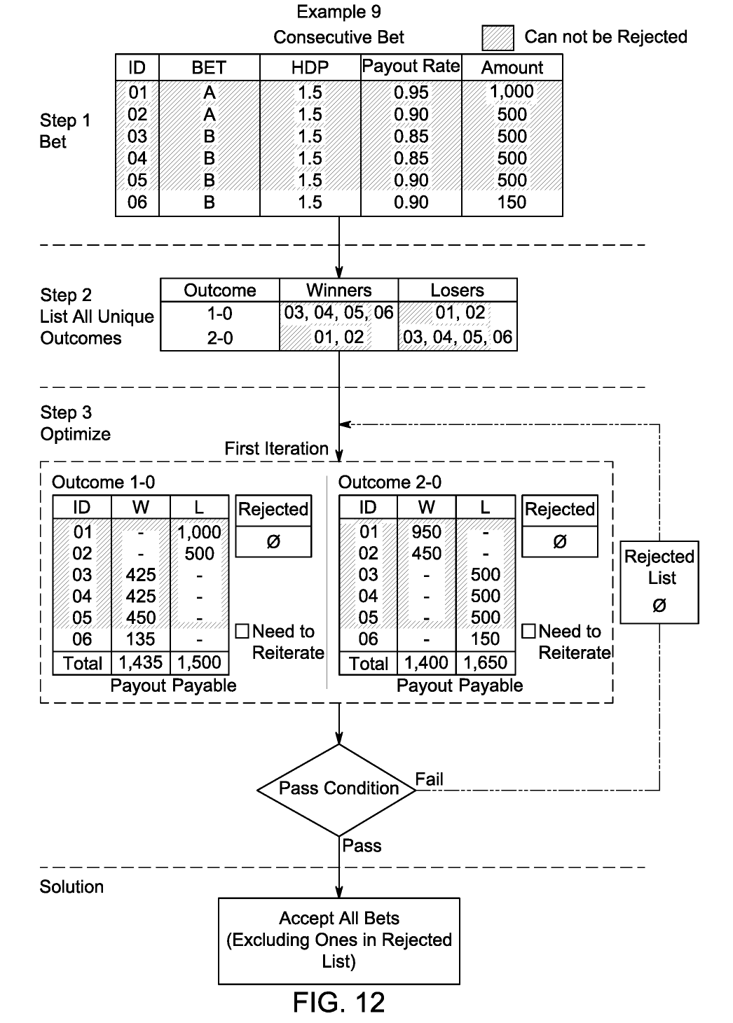

In some example embodiments, the computing devices 101 communicate with the bet management system 110 to view betting information, place bets, track bets, and the like, as described in further detail below with reference to FIGS. 2-19. More specifically, the players can interact with the bet management system 110 via interfaces illustrated in FIGS. 12-19.

In some example embodiments, the bet management system includes input and output means (e.g., mouse, keyboard, monitor), which allow players to communicate directly with the bet management system. For example, the bet management system may be, or may include, a kiosk or central computing station, at which multiple players can view, manage and place bets as described herein.

Although not illustrated in FIG. 1, the bet management system 110 and/or computing devices 101 may be communicatively coupled to an operator system and/or computing device. In some example embodiments, the operator system takes bets from bettor systems (e.g., 101) and transmits those bets to the bet management for analysis and/or processing.

### Bet Management Process

FIG. 2 is a flow chart illustrating a process for managing bets according to an exemplary embodiment. As described above with reference to FIG. 1, managing bets may be performed by a bet management system receiving bets (e.g., locally, over a network) from players (e.g., via player systems, via betting system).

As shown in FIG. 2, the bet management system receives inputs (e.g., bets) from players. A bet may be input in variety of ways. For example, a bet may be selected and input using one or a combination of input features and devices (e.g., click, tap, screen, mouse, keyboard). In some example embodiments, a bet is referred to as a bet request, indicating that the bet is being requested and not yet finally approved. The bet is a bet corresponding to a match, contest, game, or the like, between at least two teams, contestants, or the like. The bet includes one or more of a winning team, a bet amount (e.g., money) and a payout rate.

Bets may be received and analyzed (as described below for approval or rejection) instantly or within a certain period of time (e.g., 1 minute, 2 minutes, 5 minutes, 10 minutes, 1 hour, or 1 day).

In one example embodiment shown in FIG. 2, a group of bets is received from players having corresponding player identifiers (e.g., 01, 02, 03, . . . , xx). The bets correspond to a match, event, competition or contest. The group of bets may be stored by the bet management system for collective and/or simultaneous analysis. Each player inputs a bet (shown as “xxxx” in FIG. 2) including the components described above.

In turn, the bet management system calculates and/or determines a list of all possible outcomes for the match corresponding to the bets. For example, the possible outcome of a soccer match would be the score for both teams, including 0-0, 1-0, 1-1, 0-1, 0-2, 1-2 . . . etc. Because the number of potential outcomes of a match may theoretically be infinite, the bet management system identifies and uses a finite number of potential outcomes, based in part on historic data identifying maximum scores in each type of event or competition.

The bet management system analyzes the outcomes (e.g., one outcome at a time). For each possible outcome, the bet management system determines whether each of the bets would be a winning bet or a losing bet if the match were to result in that outcome. As explained in further detail below, remaining bets from previous iterations may be analyzed to determine whether they would be winning bets or losing bets. The system would look at all the outcome listed and filter out the duplicated outcomes.

Optimizing the Risk from All the Bets

The bet management system iterates and computes repeatedly until it passes the given condition(s). In some example embodiments, the default condition is whether any of the computed outcomes requires the system to reiterate or not. It should be understood that there are several other ways to work on the criteria of this condition, to find a satisfactory solution of that given iteration.

In each iteration, the bet management system may process each outcome separately and/or independently. For each outcome, the bet management system takes all potential losers and calculates a payable amount (e.g., all the money from people/bettors who lose if the potential outcome being processed occurs). The bet management system also takes all the potential winners and calculates a payout amount (e.g., all the money needed to pay the people/bettors who win if the potential outcome being processed occurs). The system compares these two values (e.g., payout amount, payable amount) and determines whether there is enough money to pay or not (e.g., whether the payable amount equals or exceeds the payout amount).

In some example embodiments, a system threshold is used to determine whether to allow bets to be taken in cases where the payout amount is higher than the payable amount. The system threshold may be $0 by default, meaning that the system will not allow bets to be taken that are not coverable by money collected from lost bets. It should be understood that the threshold amount may be reset as desired by the system manager. For example if the payout amount is higher than payable amount by $800 (e.g., $800 short) but the system threshold is set to $1,000 (e.g., meaning the system is willing to risk up to $1,000 to increase the volume of the bet), the system will not flag this potential outcome as “need to reiterate.” On the other hand, if the system threshold is set to $500, then the system will flag this case as “need to reiterate” because the payout amount is higher than the payable amount and system threshold by $300. Moreover, in such a scenario where the payout amount is $300 higher, the bet management system flags the potential outcome as “need to reiterate” and reject some of the potential winners to maintain the system constraint. The logic of how bets are rejected is described in further detail below. The rejected bets are maintained in a list for a follow-up iteration (e.g., reiteration).

After computing all the potential outcomes in one iteration, the bet management system checks whether any of the potential outcomes are flagged with “need to reiterate” and, if so, the bet management system repeats the process in step 3 again. That is, each time that the system determines that it needs to reiterate (e.g., because all the potential outcomes have not yet passed the desired conditions), the list of rejected bets from the outcomes are combined into a list to be used for the next iteration. Rejected bets from potential winners in some outcomes must be the potential losers in some other outcomes, thus removing the bets reduces the payable amount in some other outcomes, and may cause other outcomes to fall short on payout. Therefore, in the next iteration, the system removes all the potential losers that are also listed in the rejected bets list, and recomputes everything all over again.

After one or several iterations, the system yields a solution when it determines that none of the outcomes are flagged as “need to reiterate.”

That is, in step 3, the system processes the potential outcomes and determines whether the system has enough money to pay for all cases. The system thus determines whether to accept or reject the bets. In some example embodiments, in step 3, the bet management system performs the following steps:

Step 3.1: For each outcome, the system computes the payable amount (e.g., the bet money from the potential losers).

Step 3.2: For each outcome, the system computes for payout amount (e.g., the sum of all the bet money multiplied by their respected requested payout rate).

Step 3.3: For each outcome, the system compares the value of payout amount and subtracts the payable amount from the system threshold. If the value is less than or equal to the system threshold, the system skips step 3.4 and processed step 3.5. On the other hand, if the value is greater than the system threshold, the system flags the outcome as “need to reiterate” and proceeds to step 3.4.

Step 3.4: The system sorts the potential winners by the order of requested payout rate (e.g., lowest to highest), then the amount of bet (e.g., highest to lowest), then time of bet (e.g., earliest bet to latest bet) in case the requested rate and the amount of bet are the same. A heuristic algorithm, which is desired in further detail below, may be used to alter the sorting of the potential winners. The system keeps accepting the bets from the top of the list until it can no longer satisfy the system threshold. The remaining bets are placed in the rejected bets list.

Step 3.5: The system checks if the solution for this iteration is satisfactory. That is, if there is any outcome with a flag “need to reiterate,” the system re-iterates (e.g., proceeds to step 3.6). If there is no outcome with a flag “need to be reiterate”, then the system stops and gives solution (e.g., completes process).

Step 3.6: The system creates a “rejected list” by combining the rejected bets from step 3.4. The system reiterates the process starting from step 3.1 but only using the bets from the “rejected list.” That is, the bets from the “rejected list” are removed from the potential winners and potential losers in all potential outcomes.

### Heuristic Algorithm: Customizing the Optimization

It should be understood that a variety of sorting processes may be used to provide the desired optimum result for the bet management system (e.g., maximizing the accepted bet amount, maximizing the profit of the system, prioritize the ranking of the incoming bets etc.). In one example embodiment, the system identifies its optimum result by determining which bettor is willing to risk more based on the following criteria: (1) a person who requests lower payout rates is risking more (e.g., lower payout ratio); (2) a person who has a higher bet amount is risking more (e.g., more money at stake); (3) a person who places the bet first does not necessarily risk more, but the system may want to give priority on a first come, first served basis.

For example, in a soccer match between Brazil and Thailand, if player A bets on Thailand requesting a handicap of 2.5 goals, and player B bets on Thailand asking for a handicap of 3.5 goals, player A is determined by the system to be taking a higher risk by requesting a lower handicap. This is true because for cases or outcomes in which player A would win, player B would also win. But if the match outcome is that Brazil defeats Thailand by 3 goals, then player B would win while player A would lose.

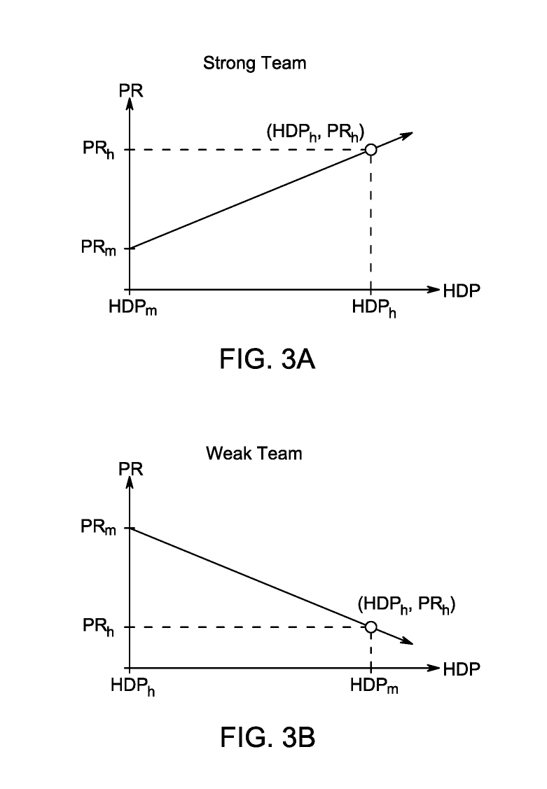

In some example embodiments, the formula below is used to identify the risk taken by players or bettors. The formula converts different bet options and handicaps into the same scale, so that risks can be more easily analyzed and compared to identify which bets are more advantageous for the system to accept. That is, the formula generates a standard payout rate from a linear scale of two given points on the relation of payout rate and handicaps. The standard payout rate and the player requested payout rate may be used to compute the scale. In some example embodiments, the scale applies to all other bet options. FIGS. 3A and 3B demonstrate the concept of standard payout rate. The following formula (Formula 1) is used to calculate the weight:

$$Weight = \frac{Payout {Rate}_{input}}{Payout {Rate}_{std}} \qquad Formula 1$$

In Formula 1, “Payout Rateᵢₙₚᵤₜ” refers to the payout rate which a player requests, and the “Payout Rate_{std}” refers to a scale given by the following linear function formula (Formula 2):

$$Payout {Rate}_{std} = ( \frac{{PR}_{h} - {PR}_{m}}{{HDP}_{h} - {HDP}_{m}} ) {HDP}_{input} + {PR}_{m} \qquad Formula 2$$

### In Formula 2:

PRₕ is a payout rate at a certain given handicap (HDPₕ) set by a bet management system administrator;
PRₘ is a payout rate at no handicap (HDPₘ) set by the bet management system administrator;
HDPₕ is a certain given handicap set by the system administrator;
HDPₘ is a handicap at money line, which is equal to 0; and
HDPᵢₙₚᵤₜ is a player requested handicap.

### EXAMPLES

In the following examples, the system threshold is set to 0. The examples are based on a soccer match as the event, in which team A is a strong team and team B is a weak team (thus handicaps goal is always given to team B). Outcome 0-0 refers to the score outcome of the match for team A-team B. If the outcome is 1-0, it would mean team A has 1 goal and team B has 0 goal.

### Example 1

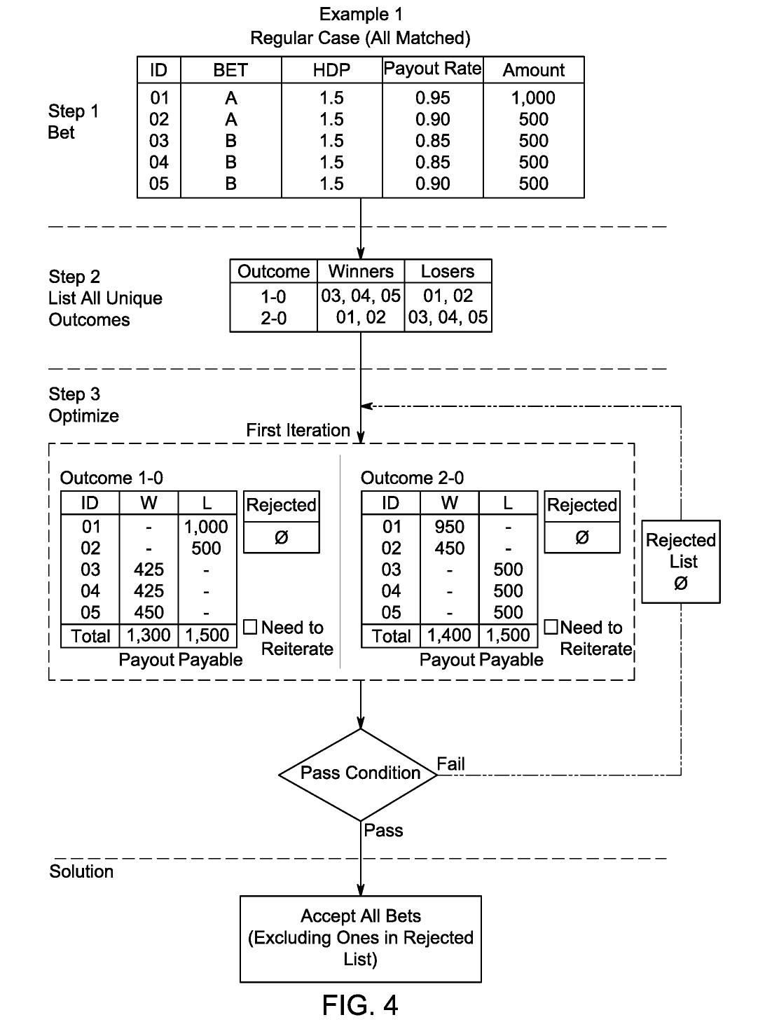

As shown in FIG. 4, five players (e.g., 01-05) input bets. Only two unique outcomes are listed because other possible scores would result with the same potential winners/potential losers as either of these two cases. For instance, if the outcome score result as 0-0, 1-1, or 2-1, the potential winners/potential losers will be listed exactly the same as the outcome score being 1-0. The two outcomes (e.g., non-duplicate outcomes) shown in step 2 are computed independently at step 3. For each case, the potential losers pay as much as the amount they bet (e.g., Player 01 would lose $1000), and the potential winners get paid by the amount they bet multiplied by their requested payout rates (e.g., Player 01 would win $950 ($1000×0.95 payout rate)).

At step 3, each of the two outcomes (e.g., 1-0 and 2-0) is processed to determine which bets to accept and which bets to reject. For the potential outcome 1-0, the system determines that, for all the bets, the payout amount would be $1300 and the payable amount would be $1500. For the potential outcome 2-0, the system determines that, for all the bets, the payout amount would $1400 and the payable amount would $1500. Because the payable amount is high enough to cover the payout amount in both cases/outcomes, neither of the cases are flagged as “need to reiterate.” That is, the system determines that by accepting all of the bets from Players 01-05, in any outcome of the event, the system would not be at a risk of losing more than it would be winning. Thus, as shown in FIG. 4, the system passes the conditions in the first iteration and provides the solution. That is, the solution is that all of the requested bets are accepted by the system.

### Example 2

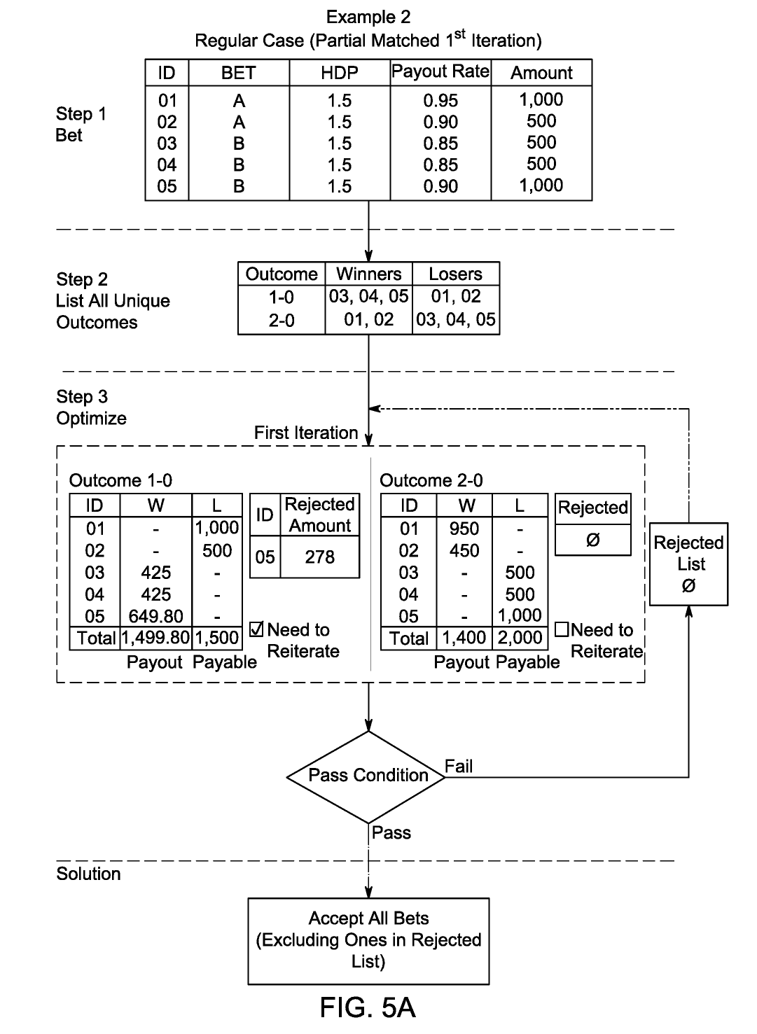

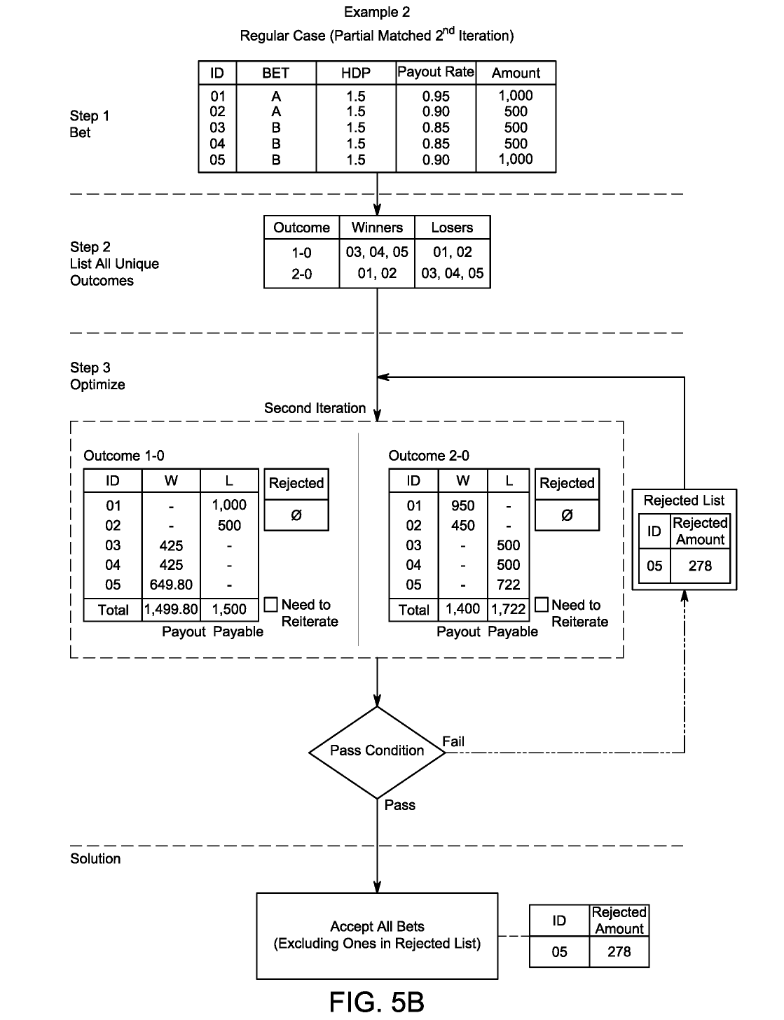

As shown in FIGS. 5A and 5B, Example 2 demonstrates a case in which not all of the bets input by Players 01-05 are matched or covered. FIG. 5A illustrates a first iteration, and FIG. 5B illustrates a second iteration. That is, in Example 2, the payout amount, in some outcomes, exceed the payable amount. In FIG. 5, the inputs and bettors are similar to those of Example 1, except the bet amount of Player 05 is increased from $500 to $1,000. In Example 2, the system performs two iterations. In the first iteration, the outcome 2-0 payout is processed without any rejected bets. On the other hand, the outcome 1-0 is short by $250 because the payout amount of the original bets is $1,750. Thus, one or more bets in the outcome 1-0 must be rejected in order for the payout amount to not exceed the payable amount.

The system partially rejects player 05 for $278 because player 05 requests the highest payout rate. That is, the system determines the amount that it is willing to accept from player 05's bet, which is $722, which would result in a payout of $649.80, at a 0.90 payout). In turn, the system flags the 1-0 outcome as “need to reiterate”, causing it to fail the system's condition. The system generates a rejected list and includes player 05 for $278, which is used in the second iteration.

In the second iteration, the outcome 1-0 remains the same while the outcome 2-0 needs to be recomputed because the bet from player 05 is down from $1,000 to $722. Because the payable amount still covers the payout amount even after reducing the amount of the bet from player 05 to $722, the system passes the condition on the second iteration. That is, reducing the bet from player 05 from $1000 to $722 allows all of the bets to be acceptable under any outcome. Thus, the system's solution is to accept the full amount of the bets from players 01, 02, 03, 04, but only accept $722 from player 05. As shown in Example 2, increasing the bet by $500 does not mean being rejected by $500. This is because the leftover buffer for each case can absorb some amount.

### Example 3

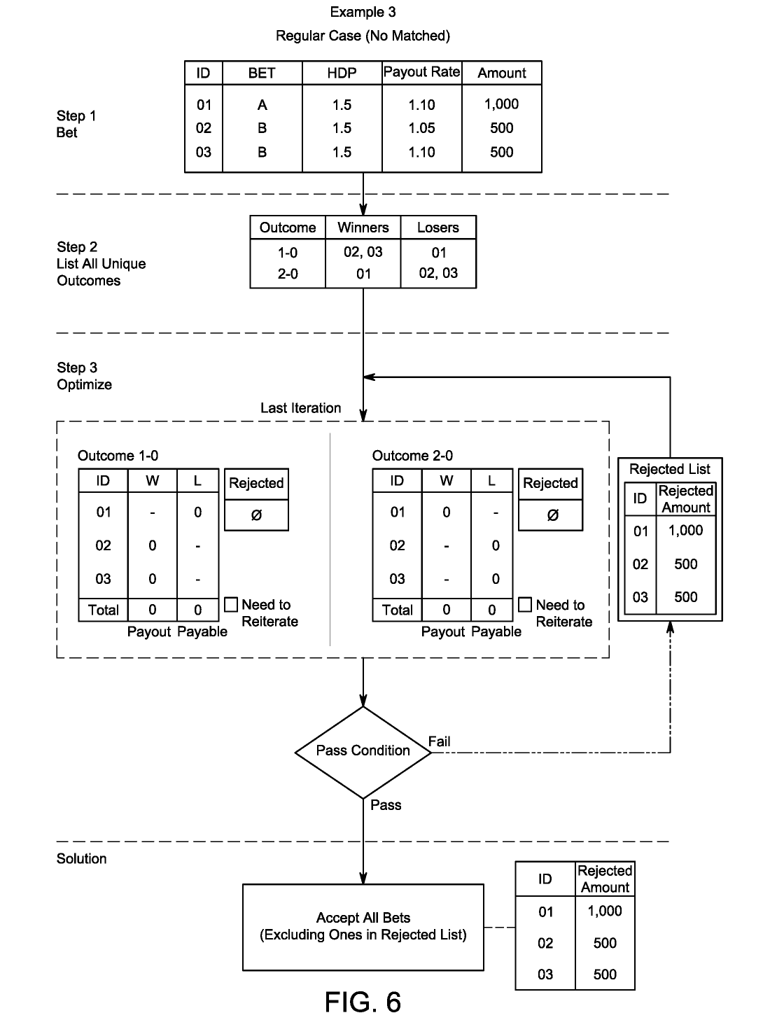

FIG. 6 illustrates Example 3, in which none of the input bets are matched. As shown in step 1, 3 players (01-03) input bets. Each of the players requests a very high payout rate (e.g., 1.10, 1.05, 1.10). Step 2 in Example 3 illustrates a list of possible outcomes and corresponding winning and losing bets or bettors. Although not shown here, the process iterates 54 times to find a solution that is satisfactory to the system. That is, the system works with decimal places, so it iterates at the rate of less than $1 reduction in the latter iterations. FIG. 6 illustrates the last of the iterations. The reason why this case does not match is because all of the players have requested a payout rate that none of them are willing to pay (asking more than giving). In each iteration, the system partially rejects certain bet amounts of players until there is none left to reject.

### Example 4

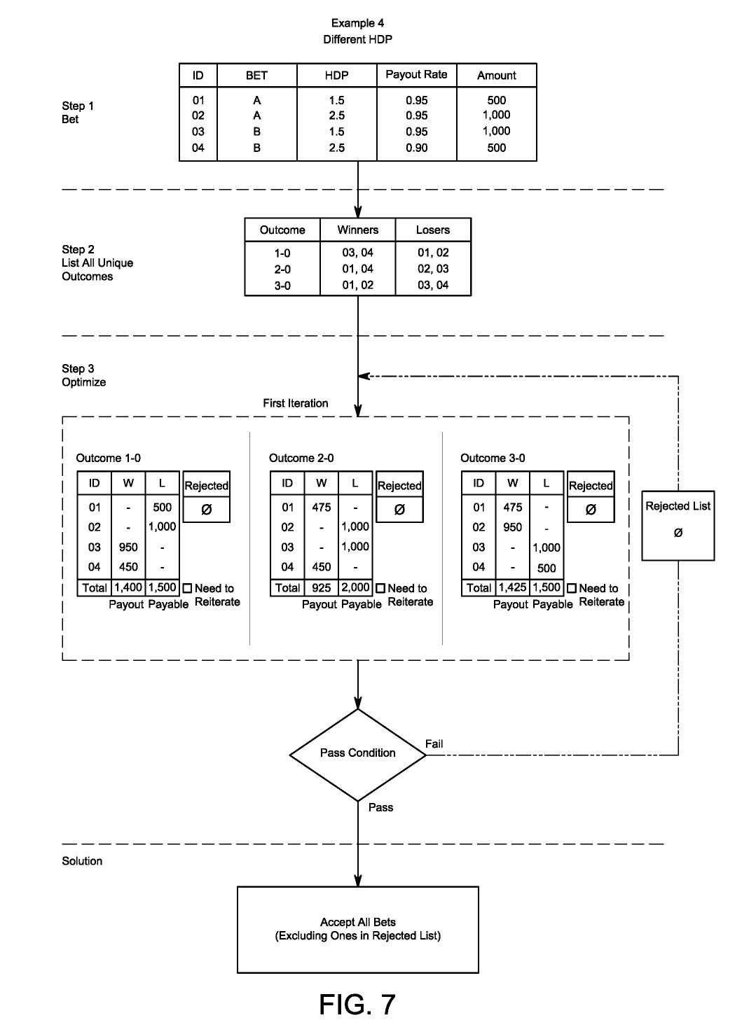

FIG. 7 illustrates Example 4, in which players 01-04 bet with different handicaps. Step 1 has 4 players betting on two different handicaps (1.5, and 2.5). Both of these handicaps are given to the weak team (e.g., to team B). At step 2, the system identifies three unique outcomes. Typically, the higher the number of handicaps, the more unique outcomes will result. In step 3, the cases are computed with resulting payable amounts that exceed the payout amount. Thus the system passes the condition and yields a solution, with all bets now being accepted.

### Example 5

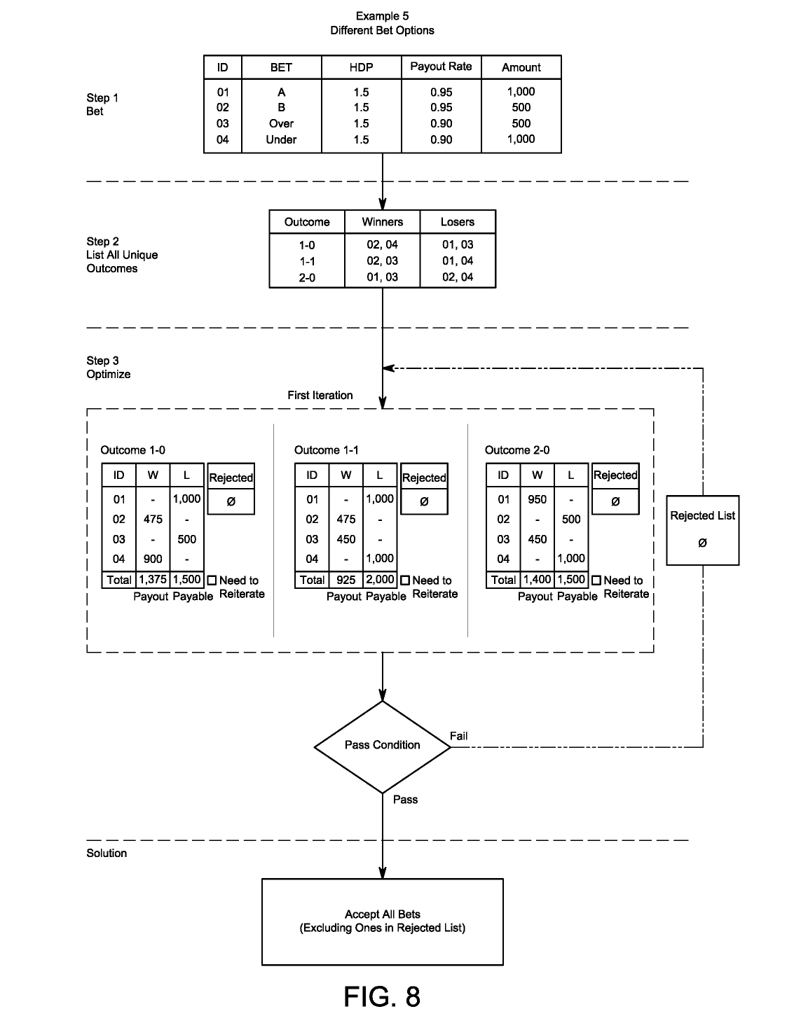

FIG. 8 illustrates Example 5, in which players bet with different bet options. As shown in FIG. 8, bets from 4 players are accepted at step 1. Player 03 plays over-under options, betting that the total combined score of the match is over 1.5 goals, while player 04 plays over/under options betting that the total combined score of the match is under 1.5 goals. In some example embodiments, having different bet options is a variation of having different handicaps. The system applies the formulas described above in order to relate the outcomes of the matches and compare the risk taken on by each of the bets. That is, the system allows different bet options to be combined and analyzed together.

### Example 6

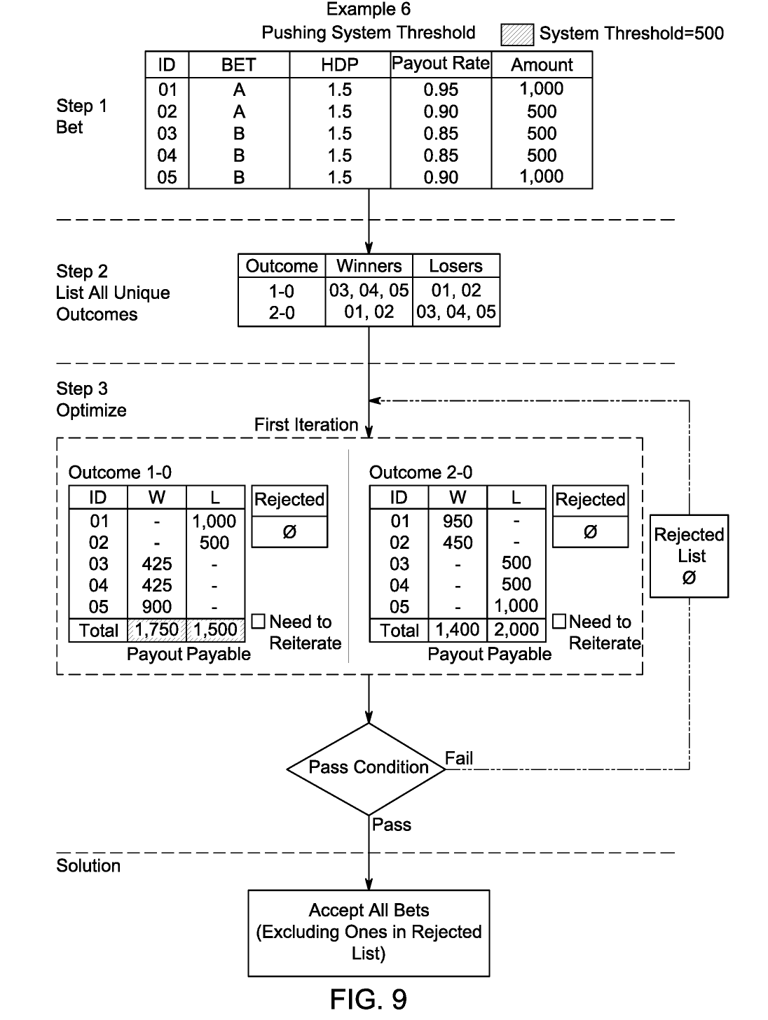

FIG. 9 illustrates Example 6, in which the system uses a system threshold. The system threshold is set to $500 for the outcomes in this example. The input in step 1 is the same as Example 2 described above. Step 2 and 3 are also the same as Example 2. However, in Example 6, for the outcome 1-0, the system computes the payout to be shorted by $250. But, because the system threshold is set to be $500, which can cover the difference, the system does not reject (e.g., partially reject) any of the bets. Instead, the system passes the condition in one iteration and the solution yields all matches. It should be understood that although the system stands the risk to potentially lose $250 on certain outcomes (outcome 1-0 and their variations), observing outcome 1-0 shows that the leftover increases by $278 (e.g., from $322 to $600). The system may adjust the threshold to play with the odds and actually bet on the outcomes of the game. The system threshold can be set, by system administrator, to different values on each outcome in the same match to comply with the risk-control policies of the system administrator.

### Example 7

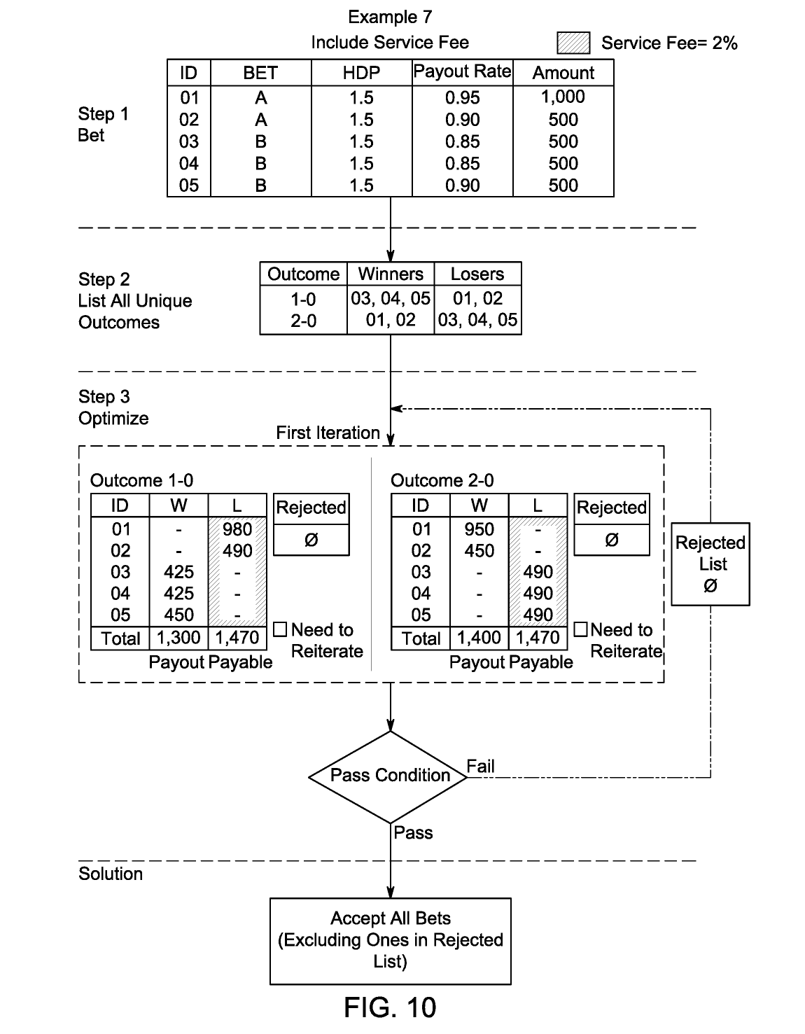

FIG. 10 illustrates Example 7, in which a service fee is included. The service fee in this example is 2% for every potential losing bet. The 2% service fee is calculated before computing the payable amount. The 2% is only charged from the potential losers (e.g., $30 off $1500 for both outcomes). This means that the system only charges approximately half of 2% from the total accepted bets in this example (total bet amount is $3,000). By including this method of charging service fees, the system may potentially reject more bets than it should because it reduces payable amount. In Example 7, the system earns the same amount of money in the end (e.g., from the leftover). However, the system threshold still guarantees the system to earn money.

It should be understood that service fees may be calculated and charged in many other ways. The service fee charging method described herein avoids charging all bettors. In some example embodiments, service fees can be a range of numbers such as 0%-5%. The system can determine whether to increase or reduce service fee to balance the bet volume. Service fees can vary from match to match.

### Example 8

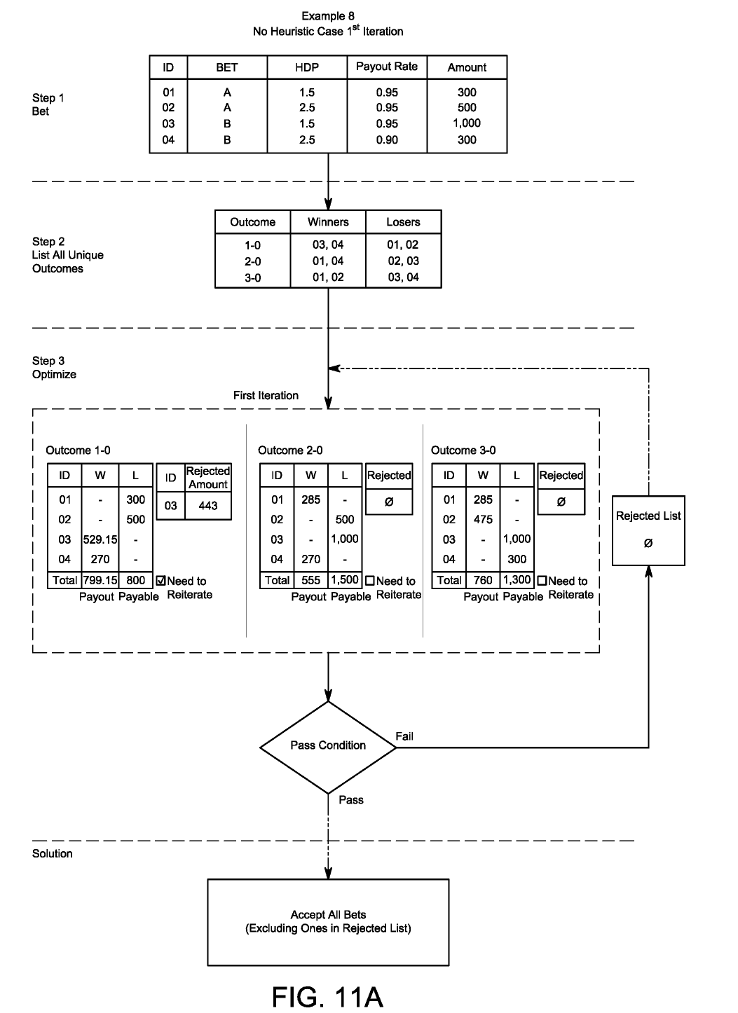

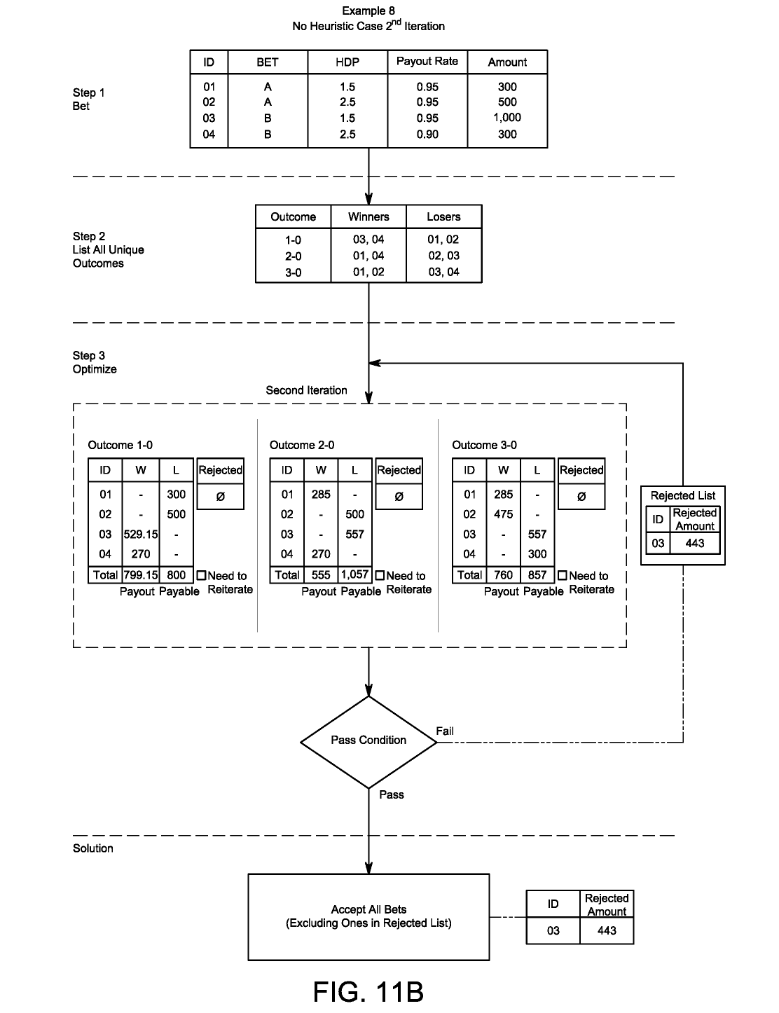

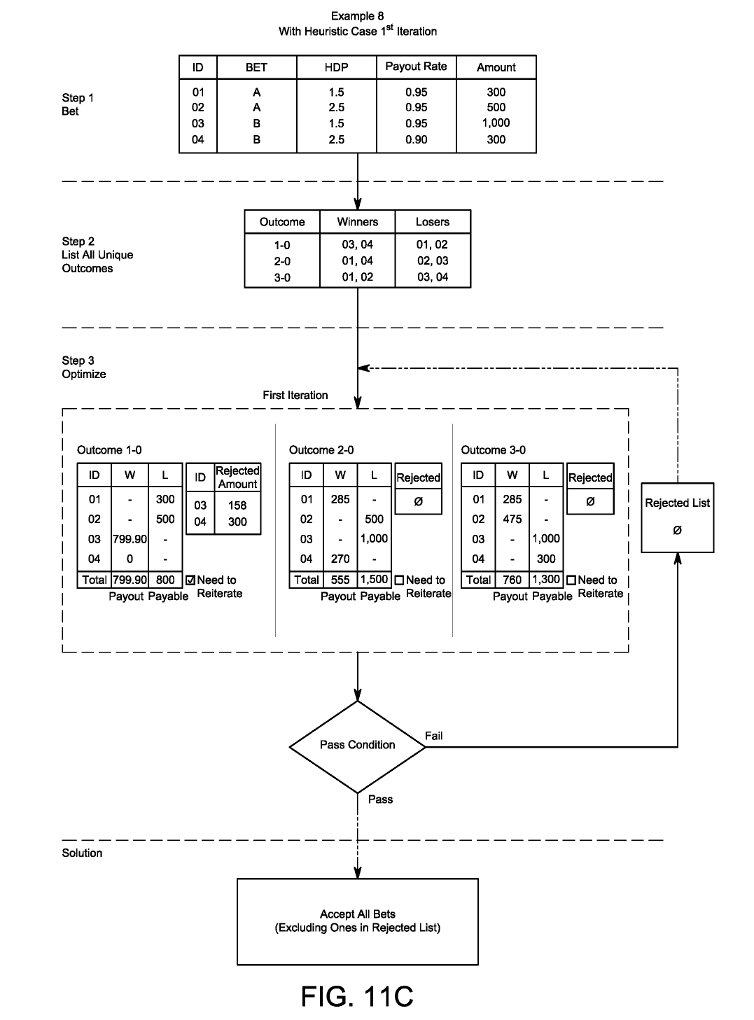

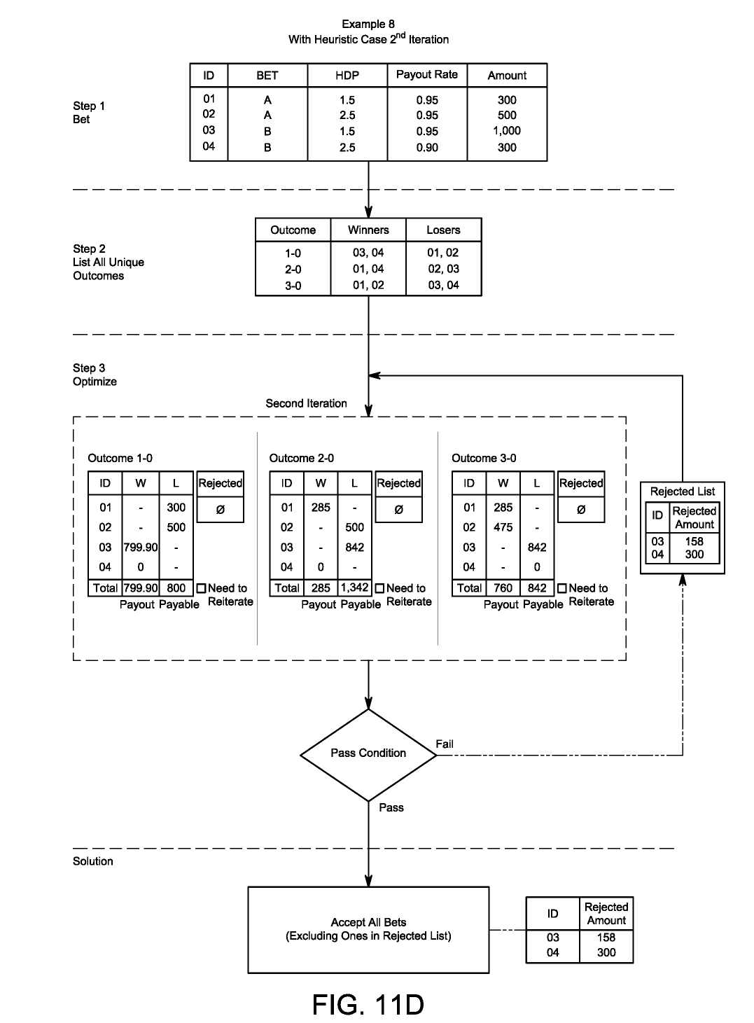

FIGS. 11A-11D illustrate Example 8, in which two cases with the same input but different sorting methods are processed. FIGS. 11A and 11B show a case in which no heuristic algorithm (e.g., default computation) is used for sorting. FIGS. 11C and 11D show a case in which a heuristic algorithm is used for sorting. In step 3 of the first iteration for both cases (e.g., FIGS. 11A and 11C), the payout amount for outcome 1-0 is too high for the system to accept and thus the system must reject some bets. In the case with no heuristic algorithm (e.g., FIG. 11A) the system accepts the bet from player 04 and partially rejects the bet from player 03 because player 04 requests a lower rate. In the case with heuristic algorithm (FIG. 11C) the system partially accepts player 03 and rejects all bets of player 04 because player 03 has a lower heuristic weight. The bet of player 03 is partially rejected because the payout amount is still too high even when the bets from player 04 are rejected.

In short, the logic of the heuristic algorithm is that player 03 betting for a weak team and requesting the lower handicap is more significant than the higher payout rate that he requested. In the second iteration, the case with no heuristic algorithm converges and yields a solution as shown in FIG. 11B. The case with heuristic algorithm converges and yield solution as shown in FIG. 11D. Thus, Example 8 shows that with different sorting algorithm the system may provide different solutions. There is no one right solution, it is all depending on what the system desires as a result.

### Example 9

FIG. 12 illustrates Example 9, in which a new player places a bet into the system after other players have already bet and had their bets accepted. At step 1 in Example 9, players 01, 02, 03, 04, 05 (e.g., similar to those from Example 1) place bets which are in turn accepted by the system. Thus, those bets cannot be rejected. Player 06 subsequently places a new bet into the system. The system accept all bets in one iteration as shown in FIG. 12, because even with the new bet, the system still has a higher payable amount than a payout amount for every outcome.

### Graphical User Interfaces

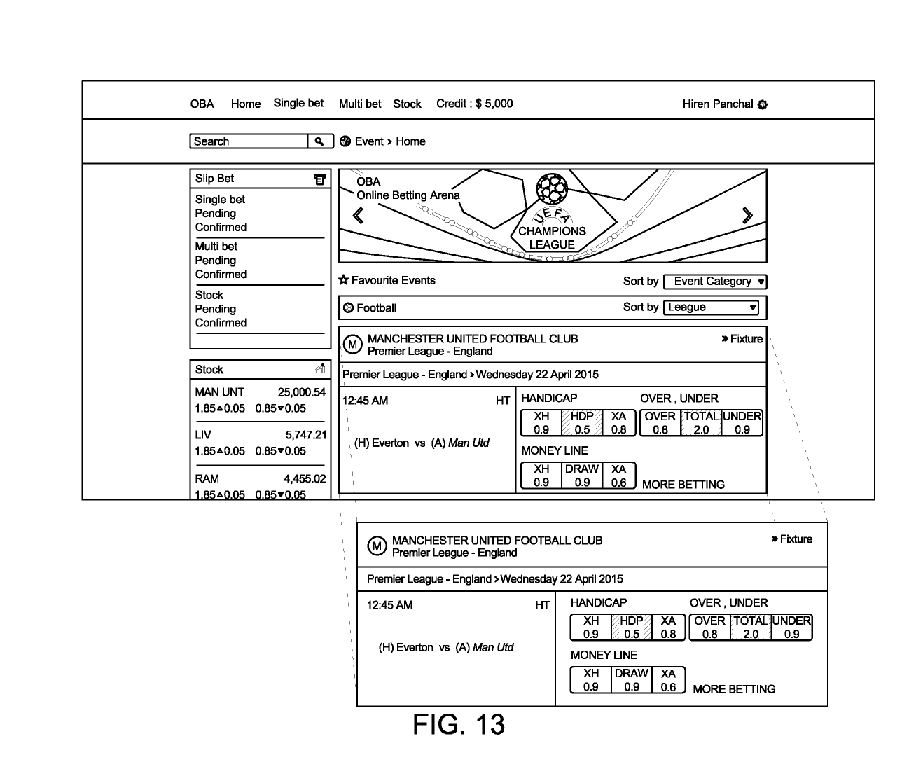

FIGS. 13-19 illustrate exemplary graphical user interfaces, widgets or the like that are displayed by and/or caused to be displayed by a bet management system. In some example embodiments, the interfaces are displayed (or caused to be displayed) at a player's (e.g., bettor's) computing device via a display. In turn, the player may view and interact with the interface to manage (e.g., input, track) bets. In some example embodiments, the interfaces are displayed and/or rendered at a display of or associated with the bet management system. For example, the bet management system may be a central betting kiosk or the like, in which multiple players may manage bets (e.g., input, view, track).

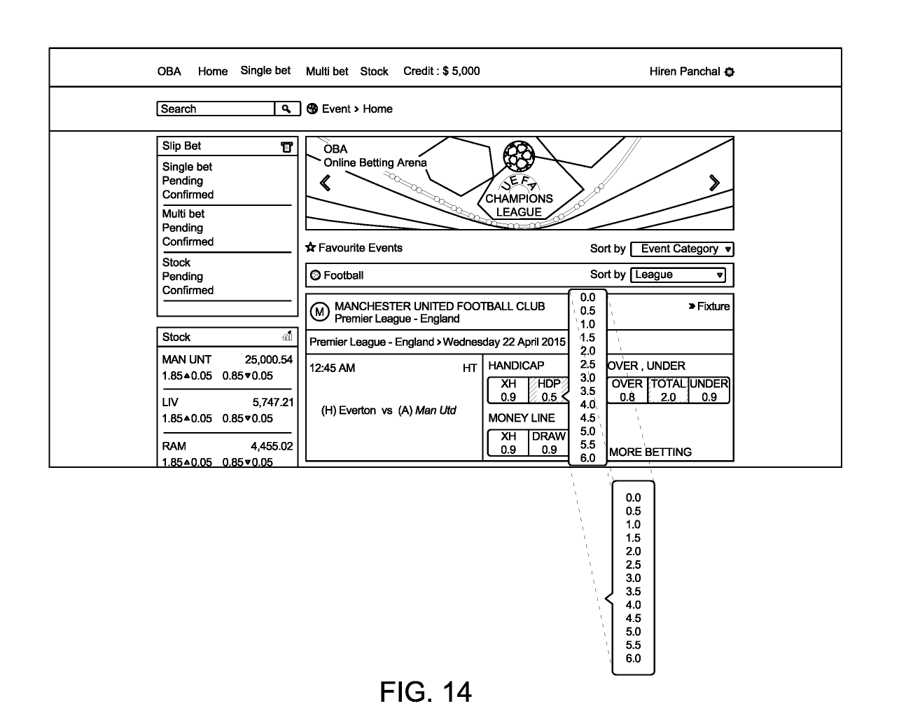

More specifically, as shown in FIG. 13, the interface provides information related to a match, including a list of available bet options. That is, the interface provides, in association with a sport (e.g., football/soccer), betting information for a selected team (e.g., Manchester United). The betting information may include the time and location of the game, the teams in the match, the home and away teams, the bet options, and the like. Selecting (e.g., clicking, tapping) the “HDP 0.5” betting option causes the interface illustrated in FIG. 14 to be displayed.

FIG. 14 illustrates an interface for selecting handicaps for a bet, according to an exemplary embodiment. The list of handicaps is displayed when the “HDP 0.5” button is selected. A user may select any of the listed handicaps to submit with a bet. In FIG. 14, a player selects 1.0 as the desired handicap.

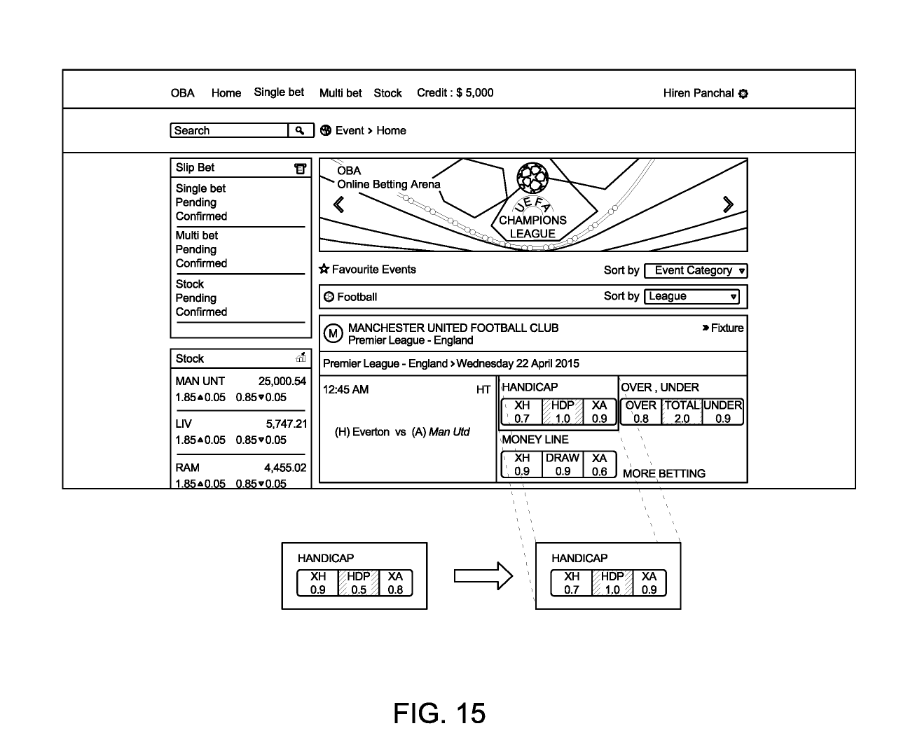

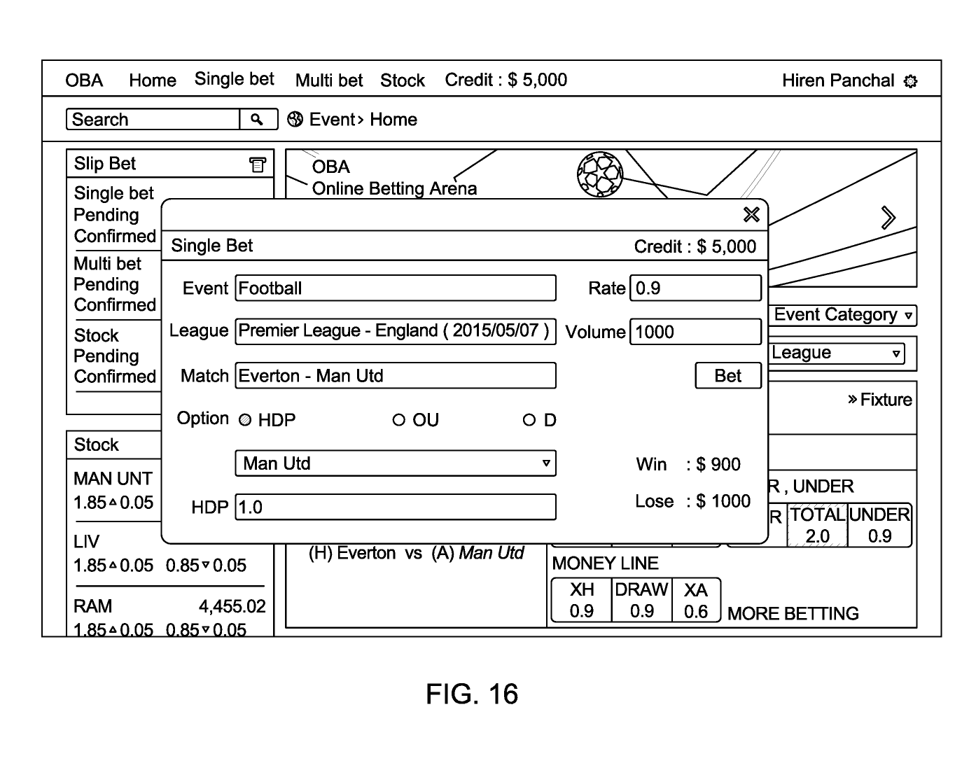

As shown in FIG. 15, selecting a handicap of 1.0 changes the adjacent XH and XA values, which show the home team (XH) and away team (XA) payout rates. The XH and XA values are changed to match the newly entered handicap. Selecting the “XA” rate of 0.9 causes the window shown in FIG. 16 to be displayed. The window includes a number of pre-filled fields outlining and/or summarizing the match and bet information. The window in FIG. 16 may be used to view the information, and can also be used to edit any of the parameters. In one example, the bet amount (e.g., volume) is changed to “1000” and the “Bet” button is selected.

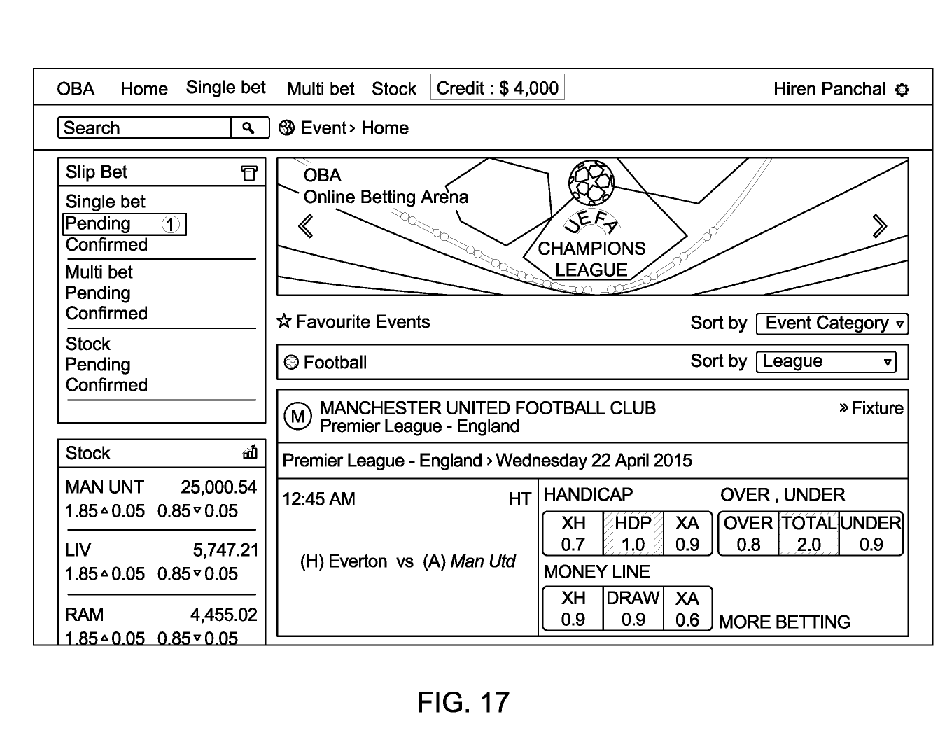

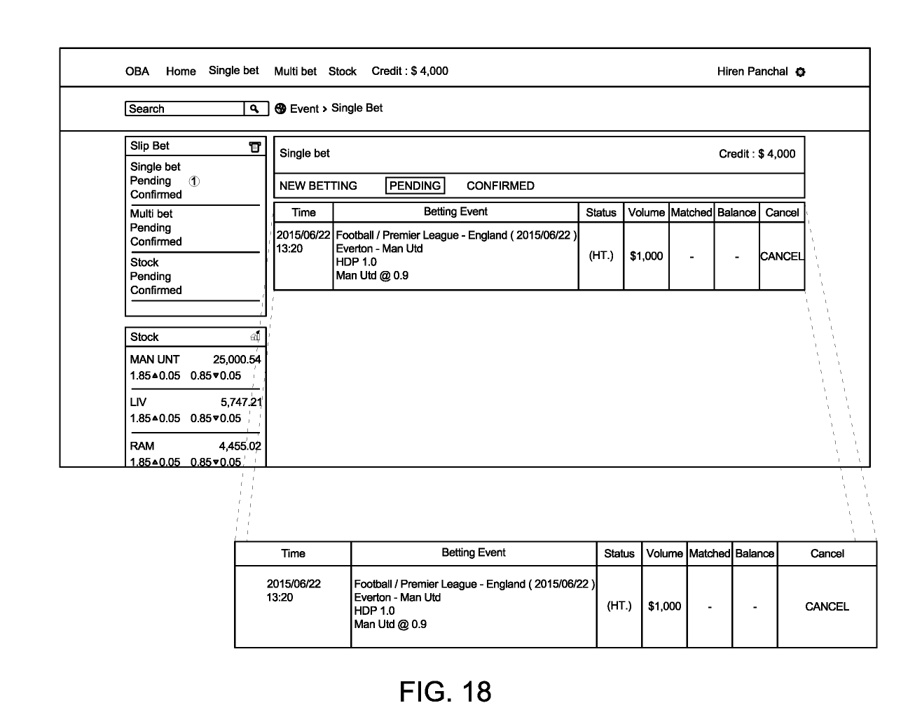

In turn, the interface at FIG. 17 is displayed. As shown in the interface of FIG. 17, the bet is listed as pending (e.g., “Pending 1”), meaning that the bet has been submitted and is awaiting processing by the system. Clicking the “Pending 1” menu option causes the interface at FIG. 18 to be shown. The interface of FIG. 18 illustrates all of the pending requests associated with a player. In the list of single bets pending, the bet information is shown as well as a “cancel” button which can be selected to terminate the bet request.

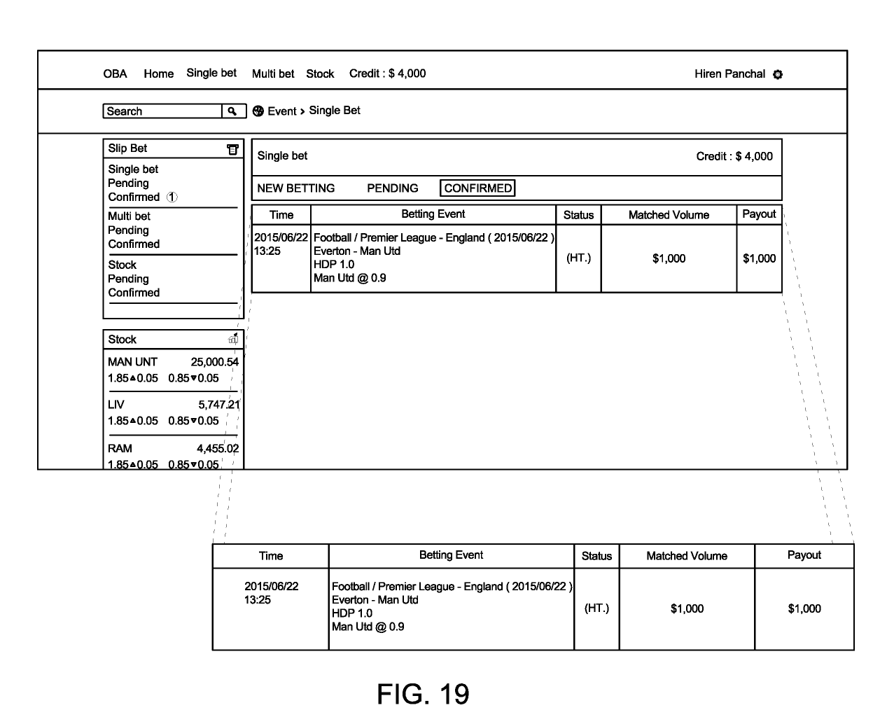

In turn, the system processes the bet (along with other bets) as described above in further detail with reference to FIGS. 2-11. As such, the bet is moved from “pending” to “confirmed”, as shown in FIG. 19 (e.g., “Confirmed 1”). In some example embodiments, bets cannot be cancelled once they have been confirmed by the system.

In some example embodiments, the bet management system serves as a stock exchange of shares corresponding to teams. That is, instead of stock being traded for companies, professional sports teams act as the companies. As described above, the bet management system generally makes earnings in betting scenarios, either through service fees, or simply by having a 0 threshold, which means that the bet management system will, at worst, not win or lose any money in connection with a sporting event. In the case that the bet management system serves as a stock exchange, the value of shares of a team are based on the amount of earnings that a bet management system makes as a result of a team's positive performance.

In one example embodiment, if team A covers spreads over a 1 month period, resulting in the bet management system making a certain amount of earnings, the stock for team A will gain value over that month. On the other hand, if the following month, team A loses consistently, the value of the stock will diminish. The amount of money earned or lost by the bet management system due to a team's performance may be made public, thereby allowing potential investors to know how much the value should appreciate or depreciate.

In some example embodiments, dividends may be paid to stock owners depending on the amount of earnings attributable to a team during a given period of time.

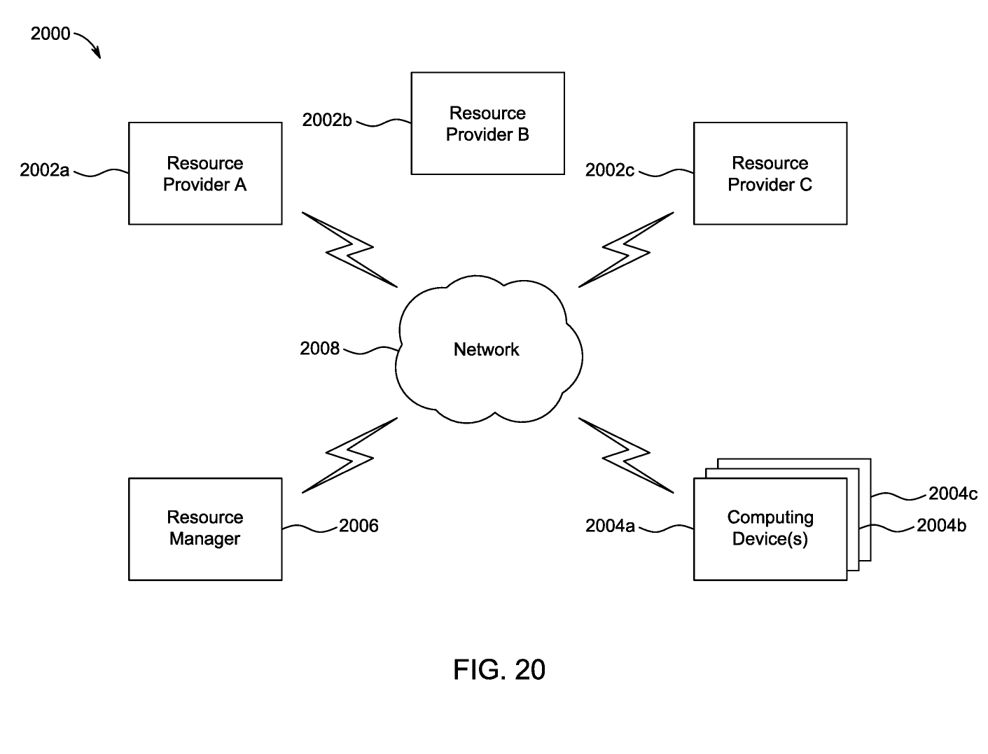

FIG. 20 shows an illustrative network environment 2000 for use in the methods and systems for managing bets, as described herein. In brief overview, referring now to FIG. 20, a block diagram of an exemplary cloud computing environment 2000 is shown and described. The cloud computing environment 2000 may include one or more resource providers 2002a, 2002b, 2002c (collectively, 2002). Each resource provider 2002 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 2002 may be connected to any other resource provider 2002 in the cloud computing environment 2000. In some implementations, the resource providers 2002 may be connected over a computer network 2008. Each resource provider 2002 may be connected to one or more computing device 2004a, 2004b, 2004c (collectively, 2004), over the computer network 2008.

The cloud computing environment 2000 may include a resource manager 2006. The resource manager 2006 may be connected to the resource providers 2002 and the computing devices 2004 over the computer network 2008. In some implementations, the resource manager 2006 may facilitate the provision of computing resources by one or more resource providers 2002 to one or more computing devices 2004. The resource manager 2006 may receive a request for a computing resource from a particular computing device 2004. The resource manager 2006 may identify one or more resource providers 2002 capable of providing the computing resource requested by the computing device 2004. The resource manager 2006 may select a resource provider 2002 to provide the computing resource. The resource manager 2006 may facilitate a connection between the resource provider 2002 and a particular computing device 2004. In some implementations, the resource manager 2006 may establish a connection between a particular resource provider 2002 and a particular computing device 2004. In some implementations, the resource manager 2006 may redirect a particular computing device 2004 to a particular resource provider 2002 with the requested computing resource.

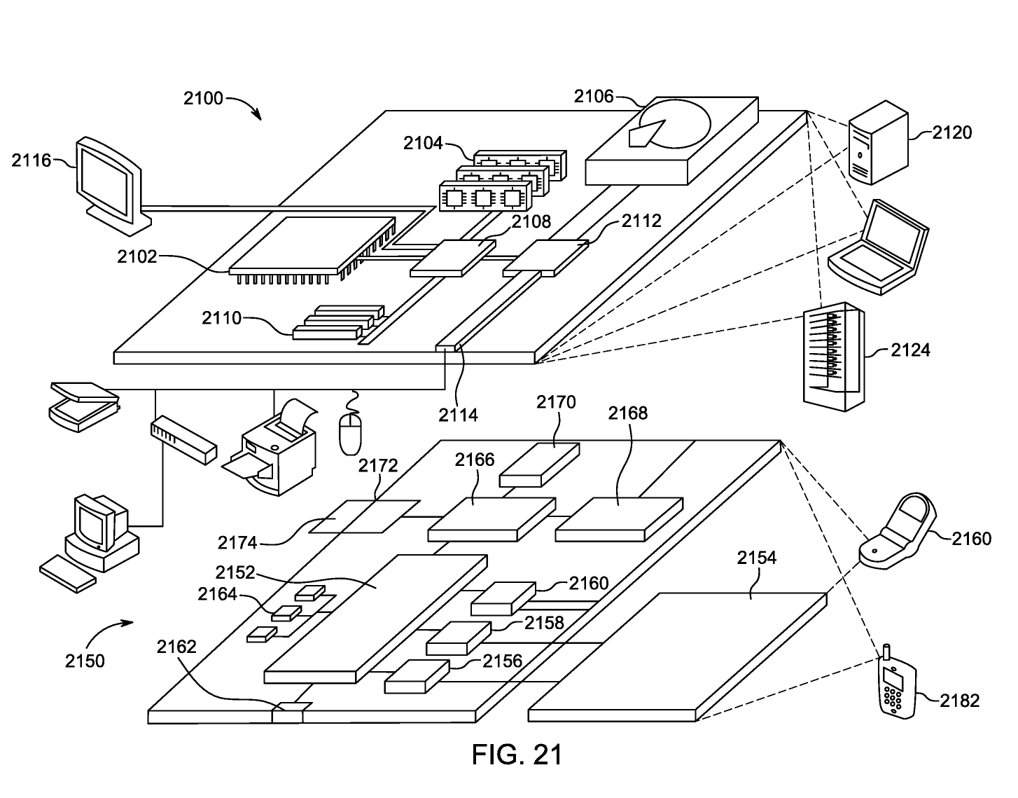

FIG. 21 shows an example of a computing device 2100 and a mobile computing device 2150 that can be used in the methods and systems described in this disclosure. The computing device 2100 is intended to represent various forms of digital computers, such as laptops, desktops, workstations, personal digital assistants, servers, blade servers, mainframes, and other appropriate computers. The mobile computing device 2150 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 2100 includes a processor 2102, a memory 2104, a storage device 2106, a high-speed interface 2108 connecting to the memory 2104 and multiple high-speed expansion ports 2110, and a low-speed interface 2112 connecting to a low-speed expansion port 2114 and the storage device 2106. Each of the processor 2102, the memory 2104, the storage device 2106, the high-speed interface 2108, the high-speed expansion ports 2110, and the low-speed interface 2112, are interconnected using various busses, and may be mounted on a common motherboard or in other manners as appropriate. The processor 2102 can process instructions for execution within the computing device 2100, including instructions stored in the memory 2104 or on the storage device 2106 to display graphical information for a GUI on an external input/output device, such as a display 2116 coupled to the high-speed interface 2108. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 2104 stores information within the computing device 2100. In some implementations, the memory 2104 is a volatile memory unit or units. In some implementations, the memory 2104 is a non-volatile memory unit or units. The memory 2104 may also be another form of computer-readable medium, such as a magnetic or optical disk.

The storage device 2106 is capable of providing mass storage for the computing device 2100. In some implementations, the storage device 2106 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 2102), perform one or more methods, such as those described above. The instructions can also be stored by one or more storage devices such as computer- or machine-readable mediums (for example, the memory 2104, the storage device 2106, or memory on the processor 2102).

The high-speed interface 2108 manages bandwidth-intensive operations for the computing device 2100, while the low-speed interface 2112 manages lower bandwidth-intensive operations. Such allocation of functions is an example only. In some implementations, the high-speed interface 2108 is coupled to the memory 2104, the display 2116 (e.g., through a graphics processor or accelerator), and to the high-speed expansion ports 2110, which may accept various expansion cards (not shown). In the implementation, the low-speed interface 2112 is coupled to the storage device 2106 and the low-speed expansion port 2114. The low-speed expansion port 2114, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 2100 may be implemented in a number of different forms, as shown in the figure. For example, it may be implemented as a standard server 2120, or multiple times in a group of such servers. In addition, it may be implemented in a personal computer such as a laptop computer 2122. It may also be implemented as part of a rack server system 2124. Alternatively, components from the computing device 2100 may be combined with other components in a mobile device (not shown), such as a mobile computing device 2150. Each of such devices may contain one or more of the computing device 2100 and the mobile computing device 2150, and an entire system may be made up of multiple computing devices communicating with each other.

The mobile computing device 2150 includes a processor 2152, a memory 2164, an input/output device such as a display 2154, a communication interface 2166, and a transceiver 2168, among other components. The mobile computing device 2150 may also be provided with a storage device, such as a micro-drive or other device, to provide additional storage. Each of the processor 2152, the memory 2164, the display 2154, the communication interface 2166, and the transceiver 2168, are interconnected using various buses, and several of the components may be mounted on a common motherboard or in other manners as appropriate.

The processor 2152 can execute instructions within the mobile computing device 2150, including instructions stored in the memory 2164. The processor 2152 may be implemented as a chipset of chips that include separate and multiple analog and digital processors. The processor 2152 may provide, for example, for coordination of the other components of the mobile computing device 2150, such as control of user interfaces, applications run by the mobile computing device 2150, and wireless communication by the mobile computing device 2150.

The processor 2152 may communicate with a user through a control interface 2158 and a display interface 2156 coupled to the display 2154. The display 2154 may be, for example, a TFT (Thin-Film-Transistor Liquid Crystal Display) display or an OLED (Organic Light Emitting Diode) display, or other appropriate display technology. The display interface 2156 may comprise appropriate circuitry for driving the display 2154 to present graphical and other information to a user. The control interface 2158 may receive commands from a user and convert them for submission to the processor 2152. In addition, an external interface 2162 may provide communication with the processor 2152, so as to enable near area communication of the mobile computing device 2150 with other devices. The external interface 2162 may provide, for example, for wired communication in some implementations, or for wireless communication in other implementations, and multiple interfaces may also be used.

The memory 2164 stores information within the mobile computing device 2150. The memory 2164 can be implemented as one or more of a computer-readable medium or media, a volatile memory unit or units, or a non-volatile memory unit or units. An expansion memory 2174 may also be provided and connected to the mobile computing device 2150 through an expansion interface 2172, which may include, for example, a SIMM (Single In Line Memory Module) card interface. The expansion memory 2174 may provide extra storage space for the mobile computing device 2150, or may also store applications or other information for the mobile computing device 2150. Specifically, the expansion memory 2174 may include instructions to carry out or supplement the processes described above, and may include secure information also. Thus, for example, the expansion memory 2174 may be provided as a security module for the mobile computing device 2150, and may be programmed with instructions that permit secure use of the mobile computing device 2150. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier and, when executed by one or more processing devices (for example, processor 2152), perform one or more methods, such as those described above. The instructions can also be stored by one or more storage devices, such as one or more computer- or machine-readable mediums (for example, the memory 2164, the expansion memory 2174, or memory on the processor 2152). In some implementations, the instructions can be received in a propagated signal, for example, over the transceiver 2168 or the external interface 2162.

The mobile computing device 2150 may communicate wirelessly through the communication interface 2166, which may include digital signal processing circuitry where necessary. The communication interface 2166 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 2168 using a radio-frequency. In addition, short-range communication may occur, such as using a Bluetooth®, Wi-Fi™, or other such transceiver (not shown). In addition, a GPS (Global Positioning System) receiver module 2170 may provide additional navigation- and location-related wireless data to the mobile computing device 2150, which may be used as appropriate by applications running on the mobile computing device 2150.

The mobile computing device 2150 may also communicate audibly using an audio codec 2160, which may receive spoken information from a user and convert it to usable digital information. The audio codec 2160 may likewise generate audible sound for a user, such as through a speaker, e.g., in a handset of the mobile computing device 2150. Such sound may include sound from voice telephone calls, may include recorded sound (e.g., voice messages, music files, etc.) and may also include sound generated by applications operating on the mobile computing device 2150.

The mobile computing device 2150 may be implemented in a number of different forms, as shown in the figure. For example, it may be implemented as a cellular telephone 2180. It may also be implemented as part of a smart-phone 2182, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

What is claimed is:

1. A method for managing subjective probability bets, the method comprising:
receiving, by the processor of a computing device, (e.g., from a bettor computing device, from an operator computing device) a first set of bets including one or more bets associated with a competition, each of the bets in the first set of bets including at least a winner (e.g., pick, desired side of bet), a payout rate, and a bet amount;
calculating, by the processor, one or more possible outcomes of the competition;
for each of the possible outcomes of the competition, determining whether each of the bets in the first set of bets would be a winning bet or a losing bet;
removing, by the processor, duplicate outcomes from the possible outcomes to arrive at a set of remaining possible outcomes;
for each of the remaining possible outcomes, performing, by the processor, a first iteration of a bet analysis procedure using the bets in the first set of bets, the bet analysis procedure comprising:
calculating, by the processor, a payable amount, the payable amount indicating incoming money from losing bets;
calculating, by the processor, a payout amount, the payout amount indicating outgoing money from winning bets;
determining, by the processor, whether the sum of the payable amount and a system threshold is greater than or equal to the payout amount, the system threshold indicating a maximum amount allowed to be paid out beyond the payable amount for the possible outcome;
in the event that it is determined that the sum of the payable amount and the system threshold is greater than or equal to the payout amount, assigning, by the processor, the outcome a pass value (e.g., no need to reiterate flag), indicating that the bets in the first set of bets are acceptable for the possible outcome; and
in the event that it is determined that the sum of the payable amount and the system threshold is not greater than or equal to (e.g., less than) the payout amount:
(i) assigning, by the processor, the outcome a fail value (e.g., need to reiterate flag), indicating that the bets in the first set of bets are not acceptable for the possible outcome (e.g., rejected bets); and
(ii) appending, by the processor, at least a portion of one or more of the bets (e.g., rejected bets) in the first set of bets to a rejected list of bets, wherein the rejected list maintains the order previously determined by the predetermined algorithm.

2. The method of claim 1, comprising:
determining, by the processor, whether any of the possible outcomes include a fail value (e.g., need to reiterate flag); and
in the event that it is determined, by the processor, that at least one of the possible outcomes includes a fail value (e.g., need to reiterate flag):
sorting, by the processor, the winning bets for the possible outcome in accordance with a predetermined algorithm, wherein the first of the sorted winning bets is the first bet to be processed in the bet analysis procedure, wherein, in the bet analysis procedure, the sorted winning bets are processed sequentially, starting with the first of the sorted winning bets, to determine if the winning bet is accepted or rejected (e.g., moved to the rejected list of bets).

3. The method of claim 2, comprising:
determining, by the processor, whether any of the possible outcomes include a fail value (e.g., need to reiterate flag); and
in the event that it is determined, by the processor, that at least one of the possible outcomes includes a fail value (e.g., need to reiterate flag):
perform, for each of the remaining possible outcomes, by the processor, one or more additional iterations of the bet analysis procedure,
wherein each of the one or more additional iterations of the bet analysis procedure is performed using the first set of bets and excluding the at least a portion of the one or more of the bets in the rejected list.

4. The method of claim 3,
wherein the bet analysis procedure succeeds (e.g., has a pass condition) if each of the remaining possible outcomes is assigned a pass value (no need to reiterate flag), and
wherein, if the bet analysis procedure succeeds:
(i) the bets in the rejected list are moved to a second set of bets; and
(ii) the bets in the first set of bets that are not in the rejected list are processed (e.g., accepted).

5. The method of claim 4,
wherein bets in the first set of bets, originated from corresponding bettor computing devices, are received, via a network, from one or more operator computing devices (e.g., casino systems, bookie systems), and
wherein the bets in the second set of bets are transmitted (e.g., distributed), via the network, to the one or more operator computing devices for further processing (e.g., analysis and/or consideration as to whether the operator computing devices will accept or reject the bets independently).

6. The method of claim 1, wherein a portion of a rejected bet is placed in the rejected list and the other portion of the rejected bet is accepted.

7. The method of claim 3, wherein the predetermined algorithm is a heuristic algorithm for determining risk based on one or more of the payout ratio, bet amount and bet time of each of a bet.

8. The method of claim 3, wherein the competition is a subjective probability type of competition including one or more of sports, events, and elections.

9. The method of claim 3, wherein the bets include a bet option selected from the group comprising standard, over-under, handicap, and money line.

10. The method of claim 9, further comprising:
calculating, by the processor, a standard payout rate based on payout rates and/or handicaps included in each of the bets,
wherein the standard payout rate indicates the risk associated with each of the bets.

11. The method of claim 1, wherein the bet analysis procedure is performed using one or more bets received during a predetermined amount of time (e.g., 5 minutes, 10 minutes, up to 1 hour before a match, up until halftime of a match) or continuously as each bet is received.

12. A system for managing subjective probability bets, comprising:
at least one memory; and
a processor coupled to the at least one memory, the processor being operable to:
receive (e.g., from a bettor computing device, from an operator computing device) a first set of bets including one or more bets associated with a competition, each of the bets in the first set of bets including at least a winner (e.g., pick, desired side of bet), a payout rate, and a bet amount;
calculate one or more possible outcomes of the competition;
for each of the possible outcomes of the competition, determine whether each of the bets in the first set of bets would be a winning bet or a losing bet;
remove duplicate outcomes from the possible outcomes to arrive at a set of remaining possible outcomes;
for each of the remaining possible outcomes, perform a first iteration of a bet analysis procedure using the bets in the first set of bets, the bet analysis procedure comprising:
calculating a payable amount, the payable amount indicating incoming money from losing bets;
calculating a payout amount, the payout amount indicating outgoing money from winning bets;
determining whether the sum of the payable amount and a system threshold is greater than or equal to the payout amount, the system threshold indicating a maximum amount allowed to be paid out beyond the payable amount for the possible outcome;
in the event that it is determined that the sum of the payable amount and the system threshold is greater than or equal to the payout amount, assigning the outcome a pass value (e.g., no need to reiterate flag), indicating that the bets in the first set of bets are acceptable for the possible outcome; and
in the event that it is determined that the sum of the payable amount and the system threshold is not greater than or equal to (e.g., less than) the payout amount:
(i) assigning the outcome a fail value (e.g., need to reiterate flag), indicating that the bets in the first set of bets are not acceptable for the possible outcome (e.g., rejected bets); and
(ii) appending at least a portion of one or more of the bets (e.g., rejected bets) in the first set of bets to a rejected list of bets, wherein the rejected list maintains the order previously determined by the predetermined algorithm.

13. The system of claim 12, wherein the processor is further operable to:
determine whether any of the possible outcomes include a fail value (e.g., need to reiterate flag); and
in the event that it is determined that at least one of the possible outcomes includes a fail value (e.g., need to reiterate flag):
sort the winning bets for the possible outcome in accordance with a predetermined algorithm, wherein the first of the sorted winning bets is the first bet to be processed in the bet analysis procedure, wherein, in the bet analysis procedure, the sorted winning bets are processed sequentially, starting with the first of the sorted winning bets, to determine if the winning bet is accepted or rejected (e.g., moved to the rejected list of bets).

14. The system of claim 13, wherein the processor is further operable to:
determine whether any of the possible outcomes include a fail value (e.g., need to reiterate flag); and
in the event that it is determined that at least one of the possible outcomes includes a fail value (e.g., need to reiterate flag):
perform, for each of the remaining possible outcomes, one or more additional iterations of the bet analysis procedure,
wherein each of the one or more additional iterations of the bet analysis procedure is performed using the first set of bets and excluding the at least a portion of the one or more of the bets in the rejected list.

15. The system of claim 14,
wherein the bet analysis procedure succeeds (e.g., has a pass condition) if each of the remaining possible outcomes is assigned a pass value (no need to reiterate flag), and
wherein, if the bet analysis procedure succeeds:
(i) the bets in the rejected list are moved to a second set of bets; and
(ii) the bets in the first set of bets that are not in the rejected list are processed (e.g., accepted).

16. The system of claim 15,
wherein bets in the first set of bets, originated from corresponding bettor computing devices, are received, via a network, from one or more operator computing devices (e.g., casino systems, bookie systems), and
wherein the bets in the second set of bets are transmitted (e.g., distributed), via the network, to the one or more operator computing devices for further processing (e.g., analysis and/or consideration as to whether the operator computing devices will accept or reject the bets independently).

17. The system of claim 12, wherein a portion of a rejected bet is placed in the rejected list and the other portion of the rejected bet is accepted.

18. The system of claim 14, wherein the predetermined algorithm is a heuristic algorithm for determining risk based on one or more of the payout ratio, bet amount and bet time of each bet.
